(19) United States
(12) Patent Application Publication
(10) Pub. No.: US 2003/0135526 A1
(43) Pub. Date: Jul. 17, 2003

(54) Method of and apparatus for examining documents, and computer program

(76) Inventor: Tadashi Ohashi, Kawasaki (JP)

Correspondence Address: STAAS & HALSEY LLP, 700 11TH STREET, NW, SUITE 500, WASHINGTON, DC, 20001, US

(21) Appl. No.: 09/879,060

(22) Filed: Jun. 13, 2001

(30) Foreign Application Priority Data
Feb. 8, 2001 (JP) 2001-032926

(51) Int. Cl. G06F 17/00

(52) U.S. Cl. 707/530; 707/511

(57) ABSTRACT

The system comprises the XML database that stores an electronic examination document, another database that stores attribute information of examiners and repliers for examining the examination document, and the main controller which allows the examination requester to select the examiner or replier on the basis of the attribute information of examiners and repliers, and requesting examination of the examination document to the selected examiner or replier through the Internet.

### FIELD OF THE INVENTION

The present invention relates to a technology of realizing document examination in an enterprise or the like by a requester/server type system configuration. More particularly, this invention relates to a technology capable of saving labor and cost required in document examination.

### BACKGROUND OF THE INVENTION

In an enterprise, hitherto, examination request documents of various projects or written materials for establishing or revising corporate rules are distributed in paper form to related departments and trading partners outside the company, and the contents of the examination request documents are examined. However, since the examination request documents are distributed in paper form, it takes much labor and cost in copying, control of distribution destinations, collection and summary control of examination results, and urging for uncollected replies. There has been a keen demand for means and method for solving these conventional problems effectively.

As mentioned above, conventionally, in an enterprise, all tasks are executed through document examinations. More specifically, an examination requester compiles an original examination request document describing the abstract of the examination requests and detail of the examination request, and copies the original document by the number of distribution destinations, and puts in envelopes. The examination requester provides the plural envelopes with distribution destination information (department, mail number, person in charge of examination, job system), and distributes a set of examination request document to each destination by using the corporate mailing system. The distribution destination information is updated according to the job system table disclosed by the job system control department on every occasion of change in personnel and organization.

When the examination request document is distributed to the person in charge of examination, the person in charge of examination examines the examination request document, and returns the reply of examination result (approval, rejection, change) in paper form to the examination requester through the mailing system. The examination requester collects reply papers of examination result from plural examiners, and summarizes the reply results. After summing up, the collected replies are reflected in the contents of the document. If the reply is not returned with the specified period, the examination requester urges the person in charge of examination by telephone or the like.

As mentioned herein, hitherto, since distribution of examination request document and collection of replies of examination results are all executed in paper form, and it requires a huge amount of sheets of paper on the whole, and it takes tremendous labor and cost in a series of document examination jobs including distribution, collection and summation.

Yet, on every occasion of change in personnel and organization, the change must be accurately reflected in the distribution destination information including the department of the distribution destination (person in charge of examination) and job system, and it is easily estimated it takes enormous labor and cost in control of distribution destination information only. In particular, in an enterprise changing the personnel and organization frequently, such problem is very serious.

### SUMMARY OF THE INVENTION

It is an object of this invention to provide a technology capable of saving labor and cost required in document examination.

According to the present invention, an electronic examination document is stored in a database, and attribute information of examiners responsible for examining the examination document is stored in another database. A requester selects an examiner on the basis of the attribute information of the examiners stored in the database, and makes a request to the selected examiner to examine the examination document. The electronic examination document is a document which is in the form of digital data and which is to be examined. The requester is a person who wants to get the examination document examined. The examiner is a person who examines the examination document.

Thus, the requester can select the examiner on the basis of the attribute information of the examiner, and make a request to that examiner through the network.

Other objects and features of this invention will become apparent from the following description with reference to the accompanying drawings.

### BRIEF DESCRIPTION OF THE DRAWINGS

FIG. 1 is a block diagram showing a configuration of an embodiment of the invention;

FIG. 2A shows an example of the user information meta information, FIG. 2B shows an example of the company information meta information, FIG. 2C shows an example of the headquarter information meta information, and FIG. 2D shows an example of the division information meta information;

FIG. 3A shows an example of the department information meta information, FIG. 3B shows an example of the project information meta information, FIG. 3C shows an example of the occupation information meta information;

FIG. 4A shows an example of the user section setting meta information, FIG. 4B shows an example of the requester setting meta information;

FIG. 5 is a flowchart explaining the operation of the embodiment;

FIG. 6 is a flowchart explaining the establishing and revising process shown in FIG. 5;

FIG. 7 is a flowchart explaining the examination requesting process shown in FIG. 5;

FIG. 8 is a flowchart explaining the request mail compiling process shown in FIG. 7;

FIG. 9 is a flowchart explaining the investigator reply process shown in FIG. 7;

FIG. 10 is a flowchart explaining the approval process shown in FIG. 7 and FIG. 11;

FIG. 11 is a flowchart explaining the examination acceptance process shown in FIG. 5;

FIG. 12 is a flowchart explaining the examination result reply process shown in FIG. 11;

FIG. 13 is a flowchart explaining the system management process shown in FIG. 5;

FIG. 14 is a diagram showing an example of user authentication screen 1000 in the embodiment;

FIG. 15 is a diagram showing an example of top menu screen 1100 in the embodiment;

FIG. 16 is a diagram showing an example of establishment, revision, and standard number input screen 1200 in the embodiment;

FIG. 17 is a diagram showing an example of original file upload screen 1300 in the embodiment;

FIG. 18 is a diagram showing an example of examination request and standard number input screen 1400 in the embodiment;

FIG. 19 is a diagram showing an example of examination request menu 1500 in the embodiment;

FIG. 20 is a diagram showing an example of request mail compiling screen 1600 in the embodiment;

FIG. 21 is a diagram showing an example of request statement compiling screen 1700 in the embodiment;

FIG. 22 is a diagram showing an example of examiner selecting screen 1800 in the embodiment;

FIG. 23 is a diagram showing an example of outside examiner selecting screen 1900 in the embodiment;

FIG. 24 is a diagram showing an example of investigator reply screen 2000 in the embodiment;

FIG. 25 is a diagram showing an example of change information input screen 2100 in the embodiment;

FIG. 26 is a diagram showing an example of approval/rejection screen 2200 in the embodiment;

FIG. 27 is a diagram showing an example of standard selecting screen 2300 in the embodiment;

FIG. 28 is a diagram showing an example of examination acceptance menu screen 2400 in the embodiment;

FIG. 29 is a diagram showing an example of request statement reference screen 2500 in the embodiment;

FIG. 30 is a diagram showing an example of original reference screen 2600 in the embodiment;

FIG. 31 is a diagram showing an example of original downloading screen 2700 in the embodiment;

FIG. 32 is a diagram showing an example of examination result reply screen 2800 in the embodiment;

FIG. 33 is a diagram showing an example of examination result reference screen 2900 in the embodiment;

FIG. 34 is a diagram showing an example of system management screen 3000 in the embodiment;

FIG. 35 is a diagram showing an example of user registration screen 3100 in the embodiment; and

FIG. 36 is a block diagram showing a modified example of the embodiment.

### DESCRIPTION OF THE PREFERRED EMBODIMENTS

One embodiment of this invention is described in detail below with reference to the accompanying drawings.

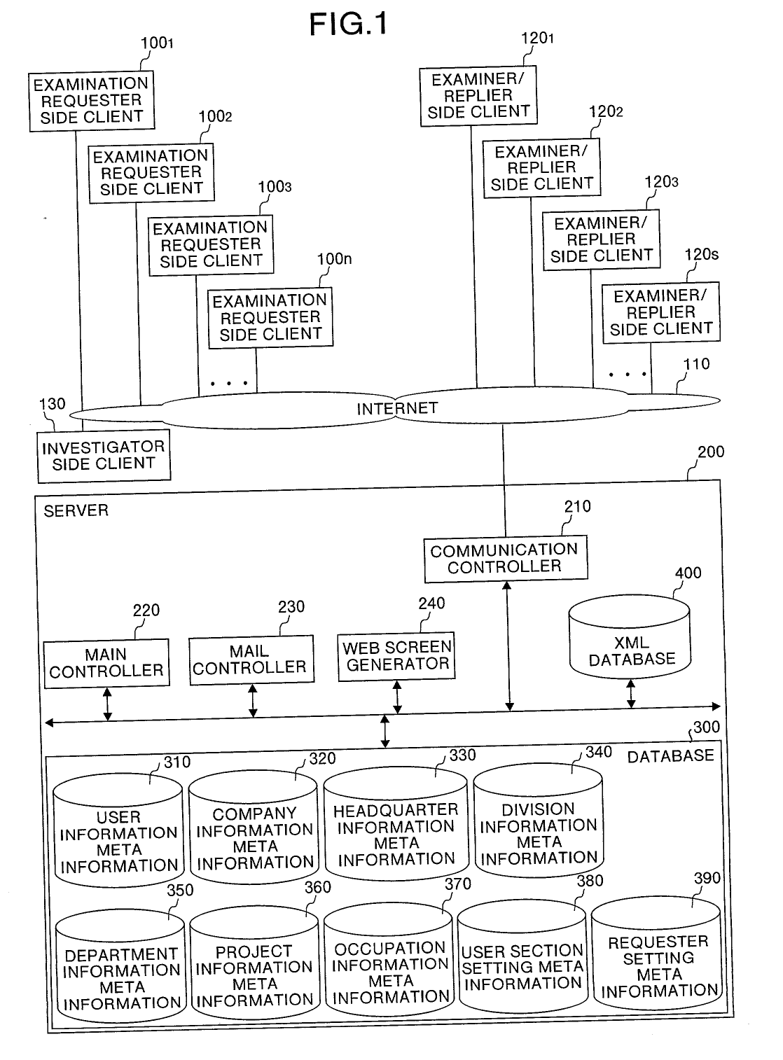

FIG. 1 is a block diagram showing a configuration of an embodiment of the invention. The diagram shows a document examination system for realizing the document examination by a client/server configuration.

This document examination system comprises examination requester side clients 100₁ to 100ₙ, examiner/replier side clients 120₁ to 120ₛ, investigator side client 130, and server 200, all connected to the Internet 110. In FIG. 1, for the sake of simplicity of explanation, communication devices necessary for connection with the Internet (terminal adapter, router, firewall, etc.) are not shown.

The examination requester side clients 100₁ to 100ₙ are n units of computers capable of accessing the server 200 through the Internet 110 according to TCP/IP (transmission control protocol/Internet protocol). Each one of these examination requester side clients 100₁ to 100ₙ is composed of computer main body, display, keyboard, mouse, etc.

These examination requester side clients 100₁ to 100ₙ are manipulated by plural document examination requesters who request the document examinations to the examiners and repliers. The examiners and repliers are those who examine the document and reply the result of examination. Further, these examination requester side clients 100₁ to 100ₙ are also provided with mailer (not shown) and Web browser.

The mailer presents a function of transmitting and receiving electronic mails through a mail server not shown. For transmission and reception of electronic mails, SMTP (simple mail transfer protocol) or POP3 (post office protocol version 3) is used. The Web browser is a software program for browsing Web pages presented by the server 200.

The examiner/replier side clients 120₁ to 120ₛ are s units of computers capable of accessing the server 200 through the Internet 110 according to the TCP/IP. Each one of these examiner/replier side clients 120₁ to 120ₛ is composed of computer main body, display, keyboard, mouse, etc.

The examiner/replier side clients 120₁ to 120ₛ are manipulated by plural examiners and repliers who are requested to examine the documents. Further, these examiner/replier side clients 120₁ to 120ₛ are also provided with mailer and Web browser.

The investigator side client 130 is a computer capable of accessing the server 200 through the Internet 110 according to the TCP/IP, and is composed of computer main body, display, keyboard, mouse, etc. This investigator side client 130 is manipulated by the investigator who investigates the object of examination before requesting the document examination. The investigator side client 130 is also provided with mailer and Web browser.

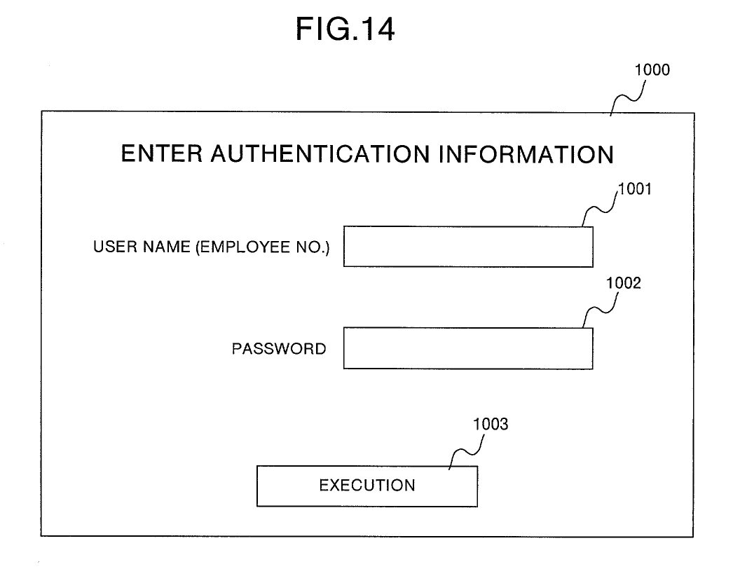

The server 200 presents various functions relating to document examination to the examination requester side clients 100₁ to 100ₙ and examiner/replier side clients 120, to 120ₛ through the Web screen (see FIG. 14 to FIG. 35) and electronic mail, and functions as a document examination apparatus. The detail of each function is described later.

In the server 200, a communication controller 210 controls the communication with an external device through the Internet 110 according to the TCP/IP. A main controller 220 controls various operations for realizing the document examination function. The detail of operation of the main controller 220 is described later. A mail controller 230 controls transmission and reception of mail between the server 200 and external device. A Web screen generator 240 automatically generates Web screens shown in FIG. 14 to FIG. 35.

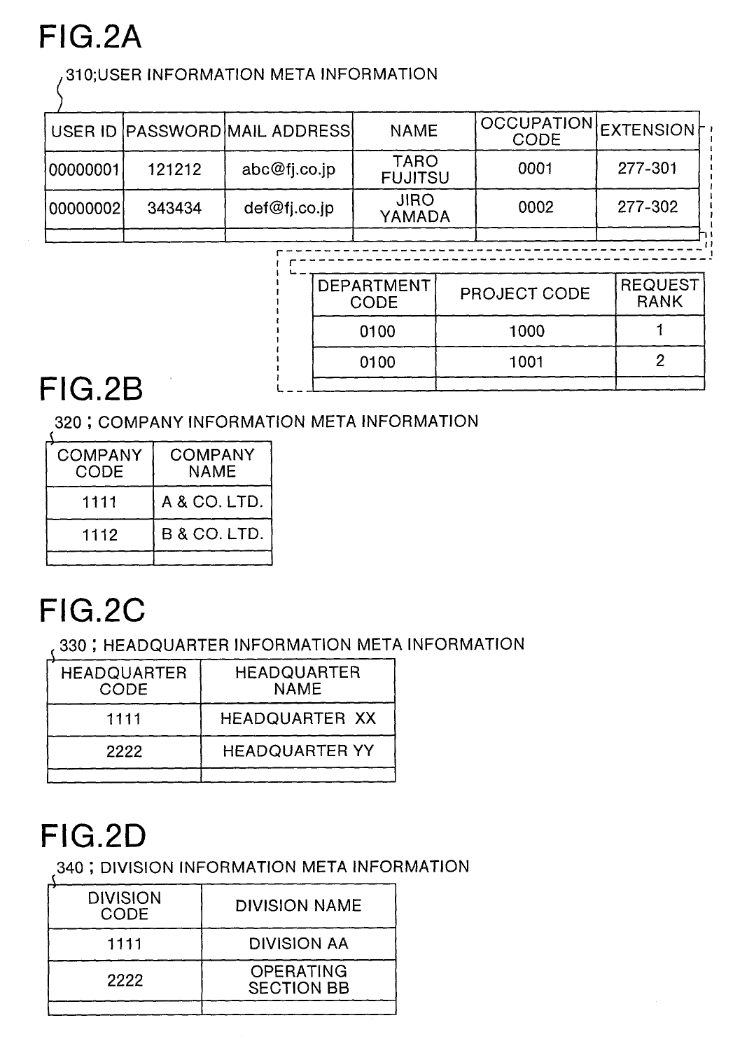

A database 300 is built in the server 200, and it stores various information by the control of the main controller 220. This database 300 is composed of user meta information 310 to requester setting meta information 390. The detail of user meta information 310 to requester setting meta information 390 is described below while referring to FIG. 2A to FIG. 4B.

The user information meta information 310 shown in FIG. 2A is the meta information composed of user information relating to the user of the server 200 (examination requester, examiner and replier), and comprises fields of user ID, password, mail address, name, occupation code, extension number, department code, project code, and request rank.

The user ID is an identifier for identifying the user, and it is, for example, an employee number. The password is used for user authentication together with the user ID. The mail address is the electronic mail address assigned to the user. The name is the information about the name of the user.

The occupation code is a code for identifying the occupational post of the user. The extension number is the extension telephone number of the user. The department code is a code for identifying the department to which the user belongs. The project code is a code for identifying the project the user is engaged with. The request rank is a numerical value set in the sequence of requesting examination in each department when the user is the examination requester.

The company information meta information 320 shown in FIG. 2B is the meta information composed of company information relating to the company using the document examination system, and comprises the fields of company code and company name. The company code is a code for identifying the company permitted to use the document examination system. The company name is the name of such company.

The headquarter information meta information 330 shown in FIG. 2C is the meta information composed of headquarter information relating to the headquarter in the organization of the company, and comprises the fields of headquarter code and headquarter name. The headquarter code is a code for identifying the headquarter. The headquarter name is the name of the headquarter.

The division information meta information 340 shown in FIG. 2D is the meta information composed of division information relating to the divisions under the headquarter in the organization of the company, and comprises the fields of division code and division name. The division code is a code for identifying the division. The division name is the name of the division.

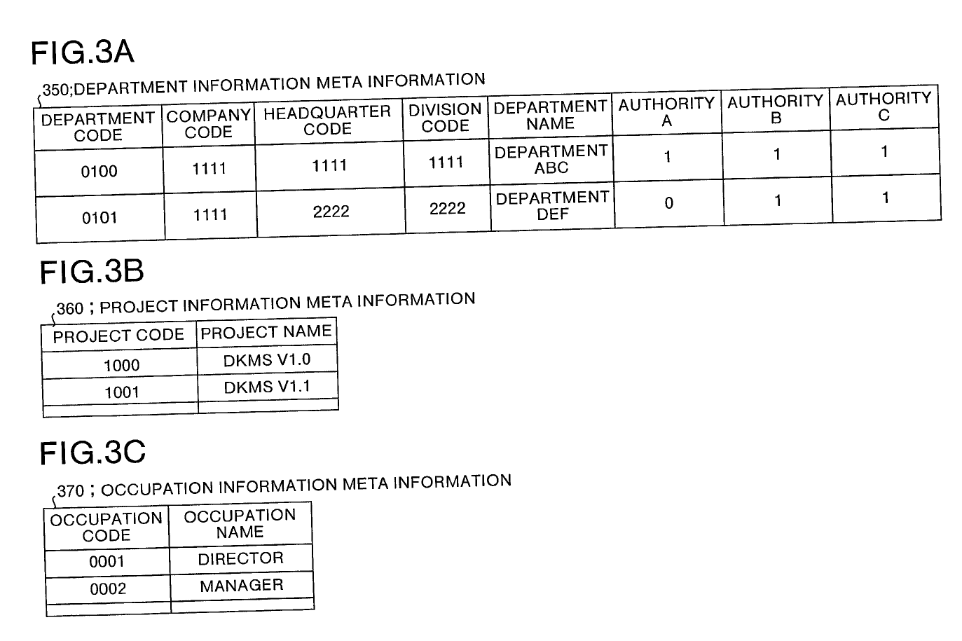

The department information meta information 350 shown in FIG. 3A is the metal information composed of department information relating to the department in the organization of the company, and comprises the fields of department code, company code, headquarter code, division code, department name, authority A, authority B, and authority C.

The department code is a code for identifying the department. The company code is same as the company code shown in FIG. 2B. The headquarter code is same as the headquarter code shown in FIG. 2C. The division code is same as the division code shown in FIG. 2D. The department name is the name of the department.

The authority A, authority B, and authority C are the information about the authority allowing the user to refer to, depending on the department belonging to, the examination document of which security level, of three security levels set on each examination document.

More specifically, three security levels are set, that is, classified disclosure level, limited disclosure level, and full disclosure level. The classified disclosure level is highest in the degree of importance of the examination level of the examination document (narrowest in the range of disclosure), and is assigned with authority A for allowing only the users in specific departments to refer to the examination document.

The full disclosure level is lowest in the degree of importance of the examination level of the examination document (widest in the range of disclosure), and is assigned with authority C for allowing the users in all departments to refer to the examination document. The limited disclosure level is an intermediate level of the classified disclosure level and full disclosure level, and is assigned with authority B for allowing the users in limited departments to refer to the examination document.

Herein, in the department information meta information 350, when the department is assigned with authority A, authority B, and authority C, flag 1 is set up. If the department is not assigned with authority A, authority B, and authority C, flag 0 is set up.

Specifically, in the case of ABC category in the first record of department information meta information 350, flat 1 is set up in all of authority A, authority B, and authority C. Therefore, users belonging to the ABC category are allowed to refer to examination documents of all security levels of classified disclosure level, limited disclosure level, and full disclosure level.

In the case of DEF category in the second record of department information meta information 350, flat 0 is set up in all of authority A, and flag 1 is set up in authority B and authority C. Therefore, users belonging to the DEF category are prohibited to refer to examination documents of classified disclosure level, but are allowed to refer to examination documents of limited disclosure level and full disclosure level.

The project information meta information 360 shown in FIG. 3B is the meta information composed of project information relating to the project in the company, and comprises fields of project code and project name. The project code is same as the project code in FIG. 2A. The project name is the name of the project.

The occupation information meta information 370 shown in FIG. 3C is the meta information composed of occupation information relating to the occupational post in the company, and comprises fields of occupation code and occupation name. The occupation code is same as the occupation code in FIG. 2A. The occupation name is the name of the occupational post.

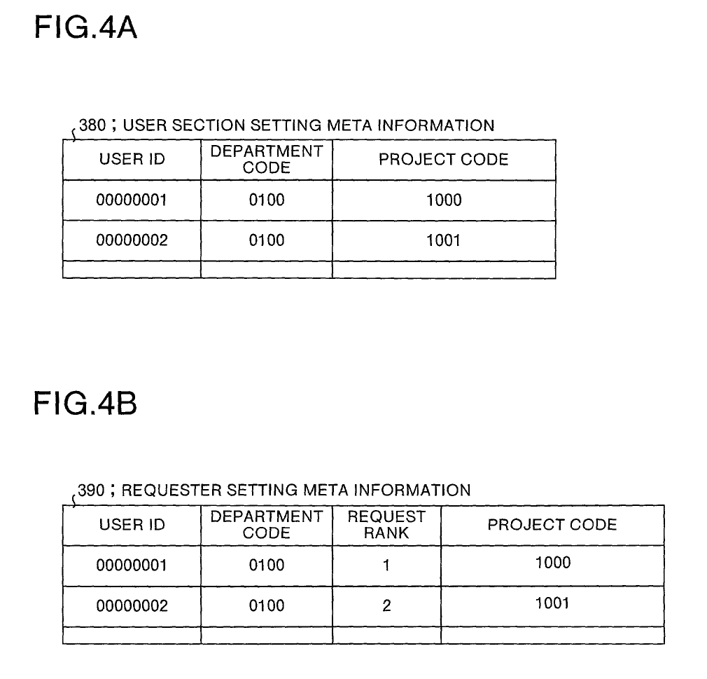

The user section setting meta information 380 shown in FIG. 4A is the meta information composed of the setting information relating to the user's section in the company, and comprises fields of user ID, department code, and project code. The user ID, department code, and project code are same as the user ID, department code, and project code shown in FIG. 2A.

The requester setting meta information 390 shown in FIG. 4B is the meta information composed of the setting information for setting the document examination requester, and comprises fields of user ID, department code, request rank, and project code. The user ID, department code, request rank, and project code are same as the user ID, department code, request rank, and project code shown in FIG. 2A.

Back to FIG. 1, the XML (extensible markup language) database 400 is a database for storing various files converted in the XML format as explained below. The XML is a highly extensible markup language allowing the user to define the own tags (hereinafter called XML tags). Also, in the XML, the information can be browsed by the Web browser, and the information can be directly drawn out from the XML database 400.

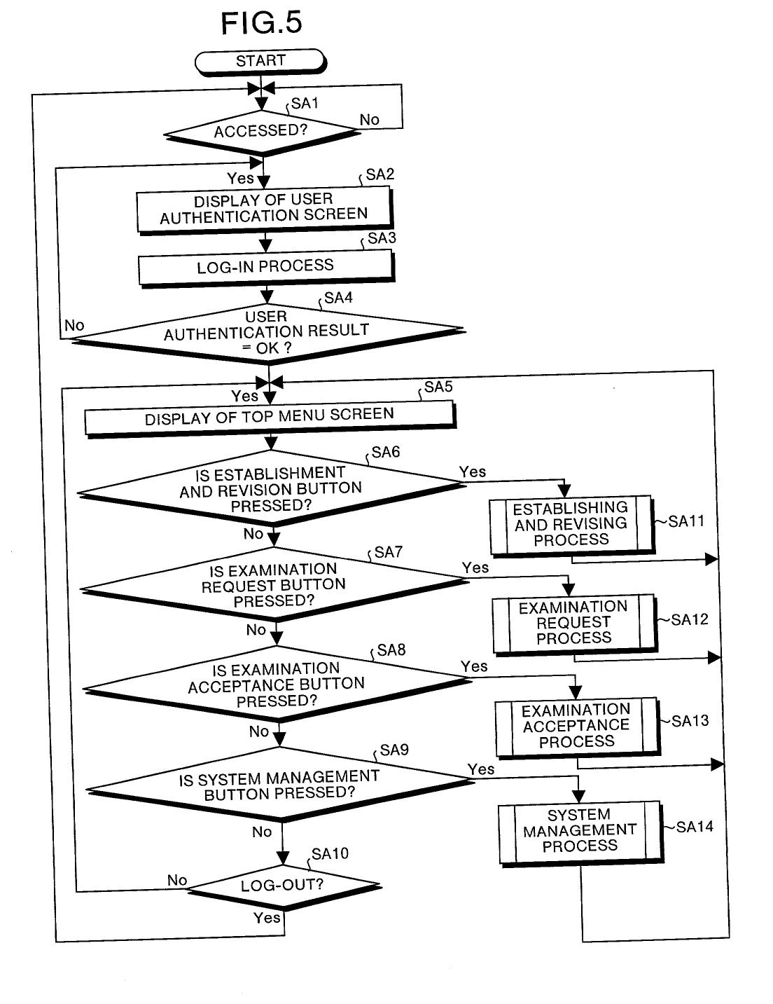

The operation of the embodiment is explained in detail wile referring to the flowcharts in FIG. 5 to FIG. 13 and the screens (Web pages) shown in FIG. 14 to FIG. 35.

At step SA1 shown in FIG. 5, the main controller 220 judges if there is any access from the examination requester side clients 100₁ to 100ₙ, examiner/replier side clients 120₁ to 120ₛ, or investigator side client 130 through the Internet 110, and if judged No, the same judgment is repeated.

When, for example, the examination requester side client 110a accesses the server 200 through the Internet 110, the main controller 220 judges Yes at step SA1. At step SA2, the main controller 220 shows a user authentication screen 1000 shown in FIG. 14 on the display (not shown) of the examination requester side client 100₁.

The user authentication screen 1000 is a screen for input of authentication information (user ID and password) necessary for authentication of the user. This user authentication screen 1000 includes a user name input column 100₁, a password input column 1002, and an execution button 1003.

At step SA3, the user enters the user ID in the user name input column 100₁, and the password in the password input column 1002, and presses the execution button 1003. As a result, log-in process is executed, and the main controller 220 collates the entered user ID and password with the user information meta information 310 (see FIG. 2A), and judges if coinciding or not to authenticate. At step SA4, the main controller 220 judges if the result of user authentication is OK (coinciding) or not, and if judged No, it is an authentication error, and the user is authenticated again at step SA2 and after.

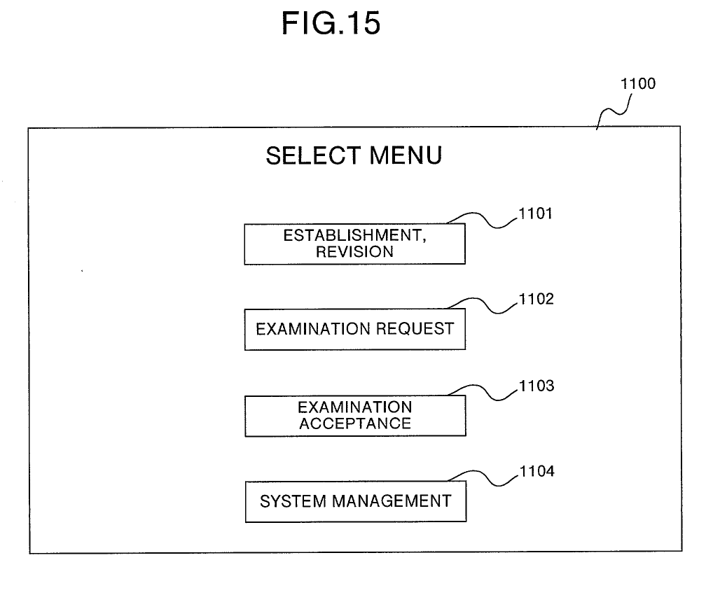

If judged Yes at step SA4, then at step SA5, the main controller 220 shows a top menu screen 1100 shown in FIG. 15 on the display (not shown) of the examination requester side client 100₁. The top menu screen 1100 is a screen for selecting any one of establishing and revising process, examination requesting process, examination accepting process, and system managing process.

The top menu screen 1100 includes an establishment and revision button 1101 for selecting establishing and revising process, an examination request button 1102 for selecting the examination requesting process, an examination acceptance button 1103 for selecting the examination accepting process, and a system management button 1104 for selecting the system managing process.

Herein, the establishing and revising process a process for newly establishing the examination document as the object of examination (electronic document about standard, rule, etc.) or revising the examination document by the examination requester. The examination requesting process is a process for requesting the examination of the examination document from the examination requester to the examiner or replier. The examination accepting process is a process for accepting the examination document requested from the examination requester by the examiner or replier. The system managing process is a process for registering new user information in the user information meta information 310 (see FIG. 2A), or changing or deleting the user information.

At step SA6, the main controller 220 judges if the establishment and revision button 1101 is pressed or not, and it is judged No in this case. At step SA7, the main controller 220 judges if the examination request button 1102 is pressed or not, and it is judged No in this case. At step SA8, the main controller 220 judges if the examination acceptance button 1103 is pressed or not, and it is judged No n this case.

At step SA9, the main controller 220 judges if the system management button 1104 is pressed or not, and it is judged No in this case. At step SA10, the main controller 220 judges if log-out or not, and if judged Yes, step SA1 is judged. If judged No at step SA10, the main controller 220 repeats from step SA5 to step SA10.

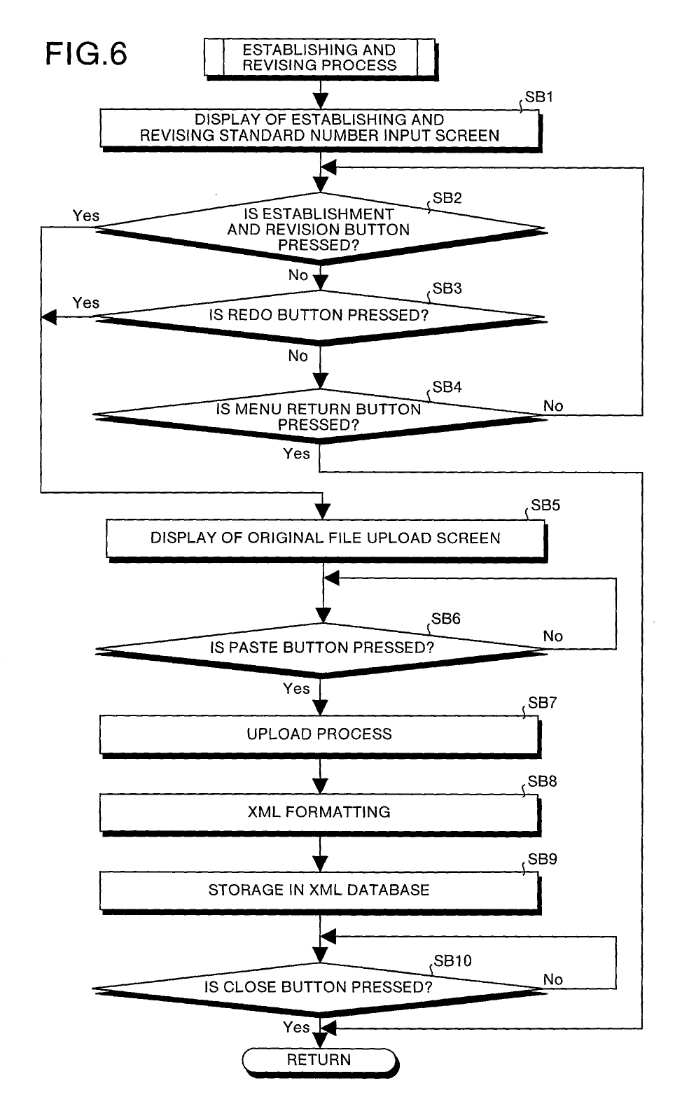

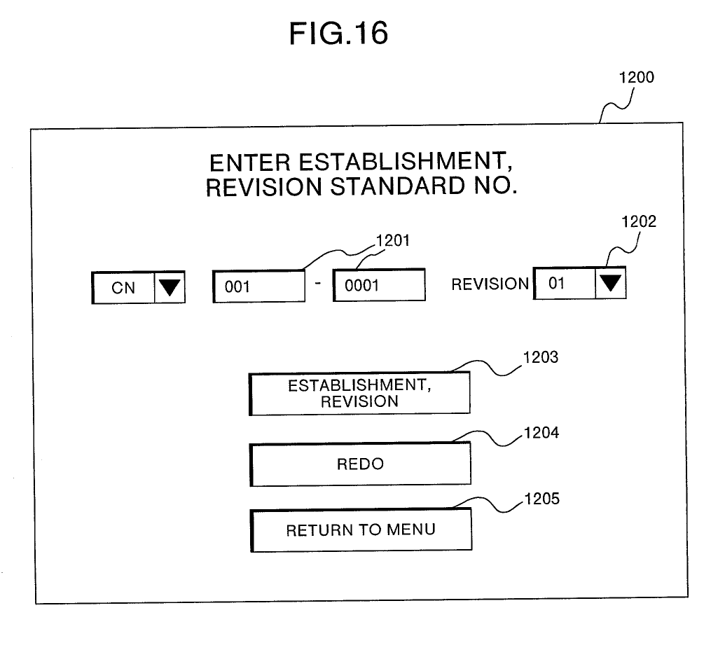

Herein, when the user (in this case, the examination requester) presses the establishment and revision button 1101, the main controller 220 judges Yes at step SA6, and the establishing and revising process is executed at step SA11. Specifically, at SB1 shown in FIG. 6, the main controller 220 shows an establishing and revising standard number input screen 1200 shown in FIG. 16 on the display (not shown) of the examination requester side client 100₁.

The establishing and revising standard number input screen 1200 is a screen for input of the standard number corresponding to the examination document to be newly established or revised. The establishing and revising standard number input screen 1200 includes a standard number input column 120₁, a version number select button 1202, an establishment and revision button 1203, a redo button 1204, and a menu return button 1205.

At step SB2, the main controller 220 judges if the establishment and revision button 1203 is pressed or not, and it is judged No in this case. At step SB3, the main controller 220 judges if the redo button 1204 is pressed or not, and it is judged No in this case. At step SB4, the main controller 220 judges if the menu return button 1205 is pressed or not, and it is judged No in this case. Thereafter, the main controller 220 repeats judgment from step SB2 to SB4.

Suppose the user (examination requester) enters a standard number in the standard number input column 120₁ and selects the version number by the version number select button 1202 (“1” in the case of new establishment, or “latest version number+1” in the case of revision). Herein, the entered standard number and version number are checked by the main controller 220 to make sure that the standard number is not same as the one already registered in the XML database 400 and that the version number selected in the case of revision is latest version number+1.

When the redo button 1204 is pressed, the main controller 220 judges Yes at step SB3, and the process of step SB5 is executed. The redo button 1204 is used when the examination result of the examination document requested for examination is rejected for replacing the rejected examination document (original file) with other examination document (original file).

When the menu return button 1205 is pressed, the main controller 220 judges Yes at step SB4, and the top menu screen 1100 (see FIG. 15) is shown on the display (not shown) of the examination requester side client 100₁ at step SA5.

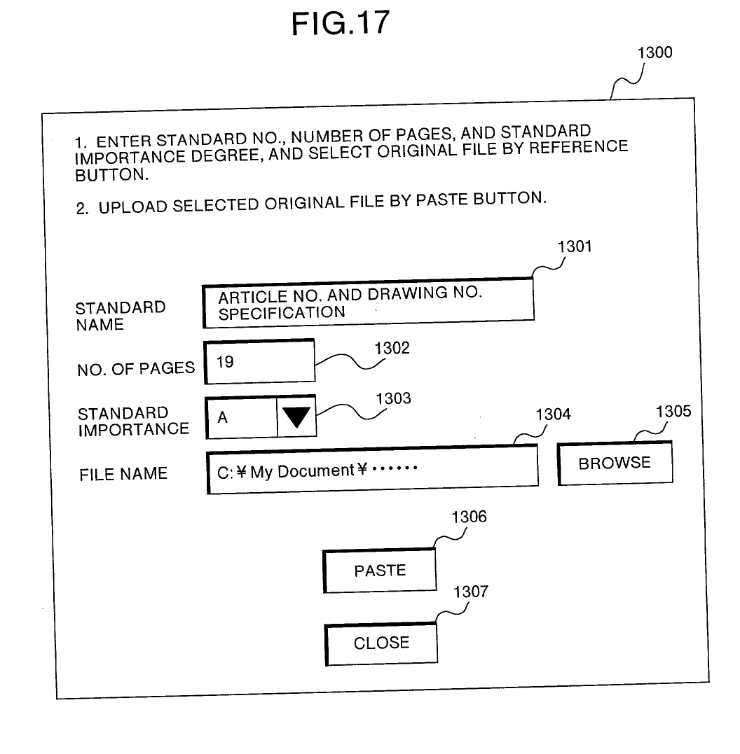

When the user (examination requester) presses the establishment and revision button 1203 (see FIG. 16), the main controller 220 judges Yes at step SB2. At step SB5, the main controller 220 shows an original file upload screen 1300 shown in FIG. 17 on the display (not shown) of the examination requester side client 100₁.

The original file upload screen 1300 is created, for example, by the examination requester, and is a screen for uploading the original file of the examination document (original) as the object of examination stored in the directory of the examination requester side client 100₁ to the server 200 (XML database 400) through the Internet 110.

The original file upload screen 1300 includes a standard name input column 1301, a total page number input column 1302, a standard importance degree select button 1303, a file name input column 1304, a reference button 1305, a paste button 1306, and a close button 1307. The standard name input column 1301 is a column for entering the name of the standard to be examined (examination document). The total page number input column 1302 is a column for entering the number of pages of the examination document. The standard importance degree select button 1303 is a button for setting the degree of importance (A, B or C) of the examination document.

The standard importance degrees A, B and C correspond to authority A, authority B, and authority C shown in FIG. 3A. That is, the standard (examination document) evaluated as standard importance degree A can be referred to only by the users in the department classified as authority A. The standard (examination document) evaluated as standard importance degree B can be referred to only by the users in the department classified as authority B. Similarly, the standard (examination document) evaluated as standard importance degree C can be referred to only by the users in the department classified as authority C.

The file name input column 1304 is a column for input of the name of the original file in the direction of, for example, examination requester side client 100₁. The reference button 1305 is a button for referring to the directory and the name of the original file. The paste button 1306 is a button for instructing start of uploading of the original file. The close button 1307 is a button closing the original file upload screen 1300.

At step SB6, the main controller 220 judges if the paste button 1306 is pressed or not, and it is judged No in this case, and the same judgment is repeated. Herein, suppose the user (examination requester) enters the standard name, number of pages and file name in the standard name input column 1301, total page number input column 1302, and file name input column 1304, and selects standard importance degree A in the standard importance degree select button 1303. When the user (examination requester) presses the paste button 1306, the main controller 220 judges Yes at step SB6.

At step SB7, upload process is executed. That is, the examination requester side client 100₁ uploads the original file in the server 200 through the Internet 110. At step SB8, the main controller 220 converts the uploaded original file into an XML document by attaching an XML tag to each phrase.

At step SB9, the main controller 220, after storing the XML formatted original file (examination document) in the XML database 400, shows the message “Upload is successful” on the display (not shown) of the examination requester side client 100₁. At step SB10, the main controller 220 judges if the close button 1307 is pressed or not, and it is judged No in this case, and the same judgment is repeated.

When the user (examination requester) presses the close button 1307, the main controller 220 judges Yes at step SB10, and the original file upload screen 1300 is closed. As a result, at step SA5 shown in FIG. 5, the main controller 220 shows the top menu screen 1100 (see FIG. 15) on the display (not shown) of the examination requester side client 100₁, and repeats the judgment from step SA6 to step SA10.

Examination of the uploaded original file (examination document) is requested in the following procedure. In this case, the user (examination requester) presses the examination requests button 1102 shown in FIG. 15. As a result, the main controller 220 judges Yes at step SA7, and examination request process is executed at step SA12.

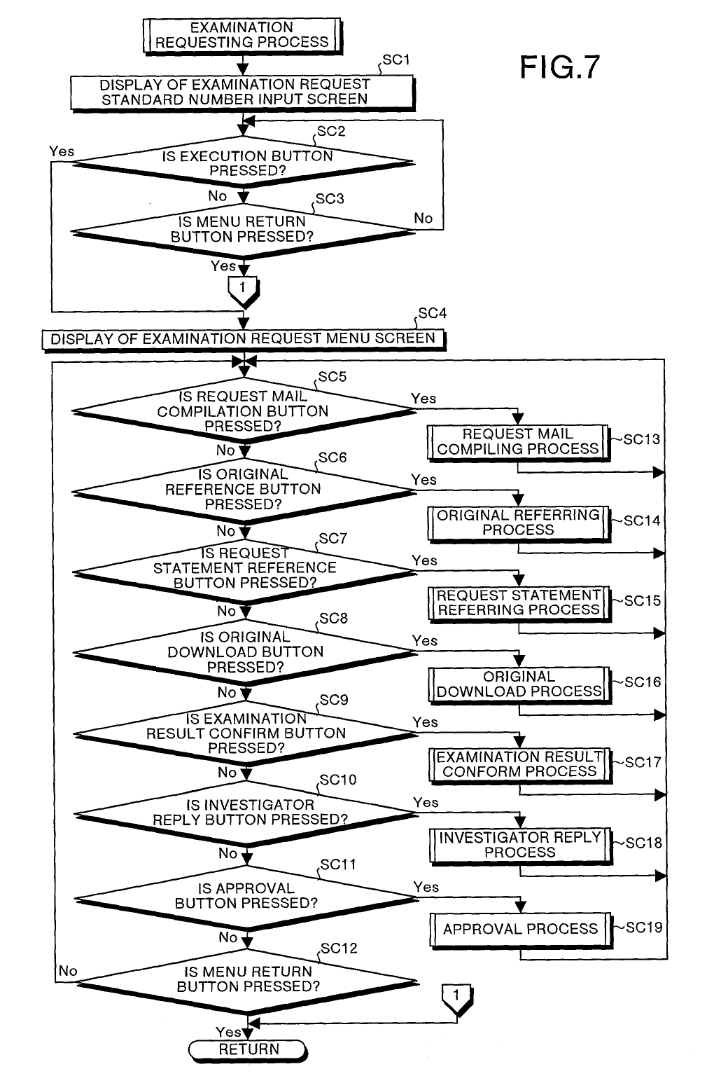

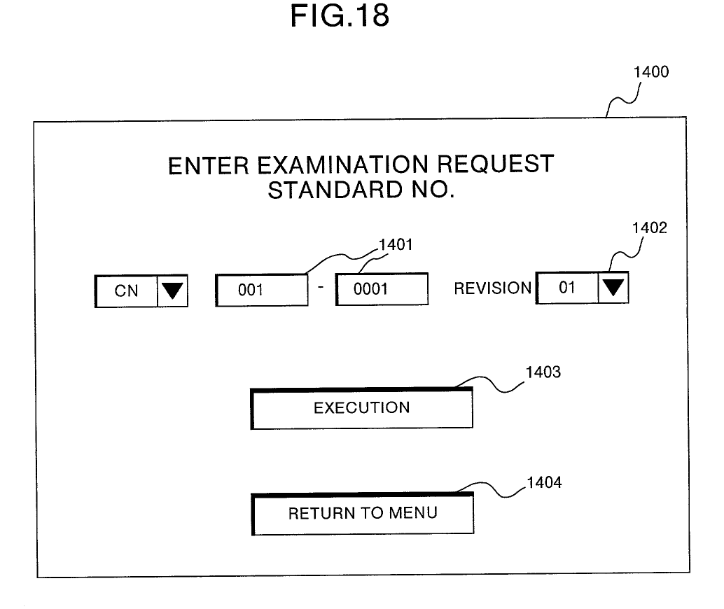

Specifically, at step SC1 shown in FIG. 7, the main controller 220 shows an examination request standard number input screen 1400 shown in FIG. 18 on the display (not shown) of the examination requester side client 100₁. This examination request standard number input screen 1400 is a screen for input of standard number corresponding to the examination document to be requested to be examined. The examination request standard number input screen 1400 includes a standard number input column 1401, a version number select button 1402, an execution button 1403, and a menu return button 1404.

At step SC2, the main controller 220 judges if the execution button 1403 is pressed or not, and it is judged No in this case. At step SC3, the main controller 220 judges if the menu return button 1404 is pressed or not, and it is judged No in this case. Thereafter, the main controller 220 repeats the judgment at step SC2 and step SC3.

Suppose the user (examination requester) enters the standard number corresponding to the examination document to be requested to be examined in the standard number input column 1401, and selects the version number by the version number select button 1402. If the menu return button 1404 is pressed, the main controller 220 judges Yes at step SC3, and the top menu screen 1100 (see FIG. 15) is displayed at step SA5 shown in FIG. 5.

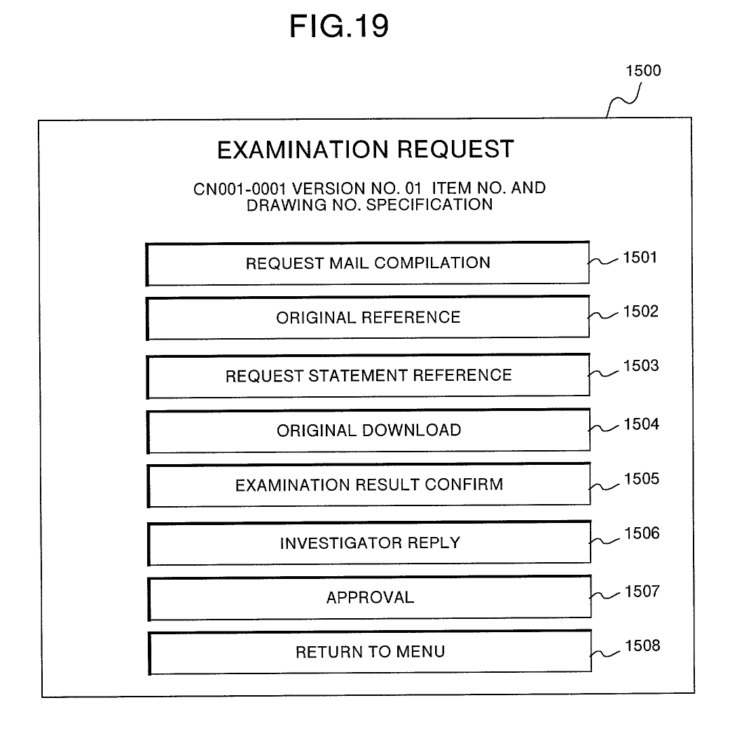

When the user (examination requester) presses the execution button 1403, the main controller 220 judges Yes at step SC2. At step SC4, the main controller 220 shows an examination request menu screen 1500 shown in FIG. 19 on the display (not shown) of the examination requester side client 100₁.

This examination request menu screen 1500 is a screen for selecting any one process of request mail compiling process, original referring process, request statement referring process, original download process, examination result confirm process, investigator reply process, and approval process. The examination request menu screen 1500 includes a request mail compilation button for selecting request mail compiling process, an original reference button 1502 for selecting original referring process, a request statement reference button 1503 for selecting request statement referring process, and an original download button 1504 for selecting original download process.

The examination request menu screen 1500 further includes an examination result confirm button 1505 for selecting examination result confirm process, an investigator reply button 1506 for selecting investigator reply process, an approval button 1507 for selecting approval process, and a menu return button 1508 for returning to the top menu screen 1100.

Herein, the request mail compiling process is a process for the examination requester to compile a request mail for requesting examination of examination document to examined, being addressed to the examiner or replier. The original referring process is a process for referring to the uploaded original file (examination document). The request statement referring process is a process for referring to the request statement (request mail). The original download process is a process for downloading the original file uploaded in the server 200 to, for example, the examination requester side client 100₁ through the Internet 110. This original file can be used as a model for examination document at the examination requester side. Therefore, the examination requester can compile the examination document easily and in a short time on the basis of the model.

The examination result confirm process is a process for the examination requester to confirm the examination result of the examination document. The investigator reply process is a process for replying the result of investigation of the examination document by the investigator. The approval process is a process for approving (or rejecting) the examination request.

At step SC5, the main controller 220 judges if the request mail compilation button 1501 is pressed or not, and it is judged No in this case. At step SC6, the main controller 220 judges if the original reference button 1502 is pressed or not, and it is judged No in this case. At step SC7, the main controller 220 judges if the request statement reference button 1503 is pressed or not, and it is judged No in this case.

At step SC8, the main controller 220 judges if the original download button 1504 is pressed or not, and it is judged No in this case. At step SC9, the main controller 220 judges if the examination result confirm button 1505 is pressed or not, and it is judged No in this case.

At step SC10, the main controller 220 judges if the investigator reply button 1506 is pressed or not, and it is judged No in this case. At step SC11, the main controller 220 judges if the approval button 1507 is pressed or not, and it is judged No in this case. At step SC12, the main controller 220 judges if the menu return button 1508 is pressed or not, and it is judged No in this case.

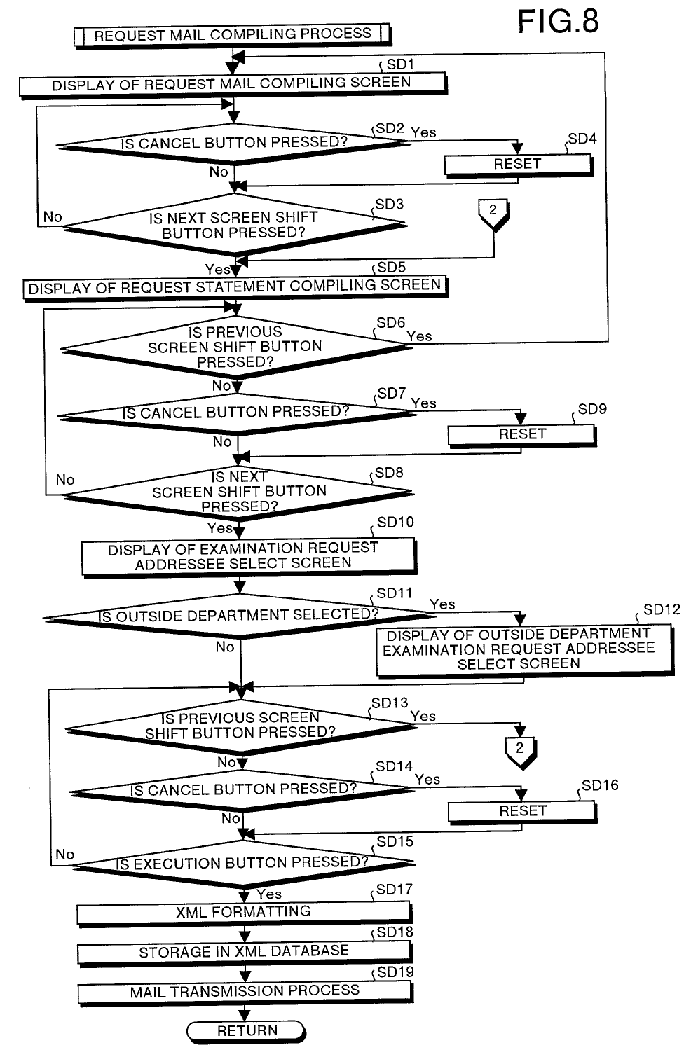

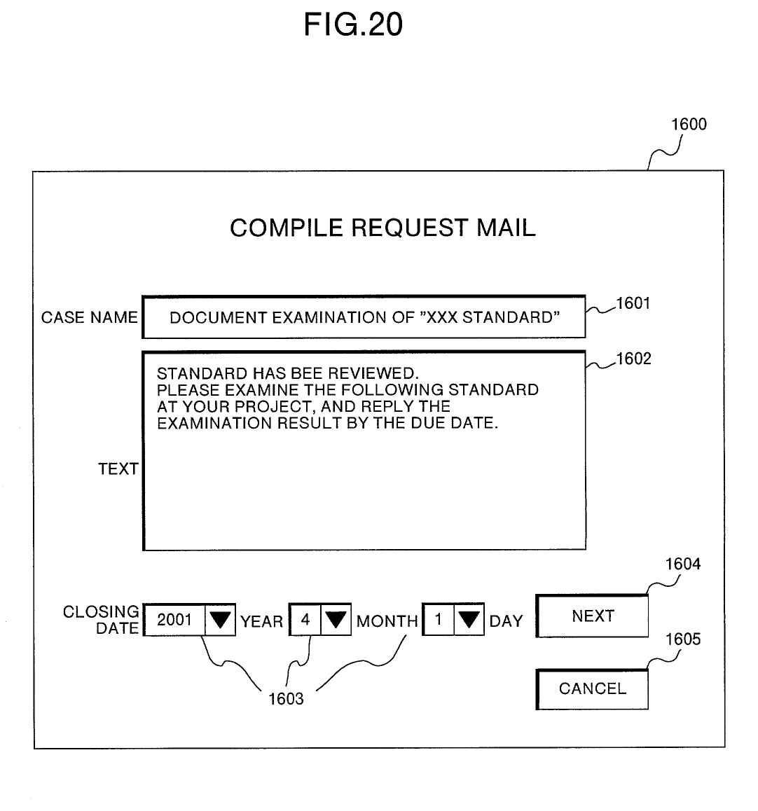

When the user (examination requester) presses the request mail compilation button 1501, the main controller 220 judges Yes at step SC5, and the request mail compiling process is executed at step SC13. Specifically, at step SD1 shown in FIG. 8, the main controller 220 shows a request mail compilation screen 1600 shown in FIG. 20 in the examination requester side client 100₁.

This request mail compilation screen 1600 is a screen for compiling a request mail. The request mail compilation screen 1600 includes a case name input column 1601, a text input column 1602, a closing day select button 1603, next screen shift button 1604, and a cancel button 1605. The case name input column 1601 is a column for input of case name in the request mail.

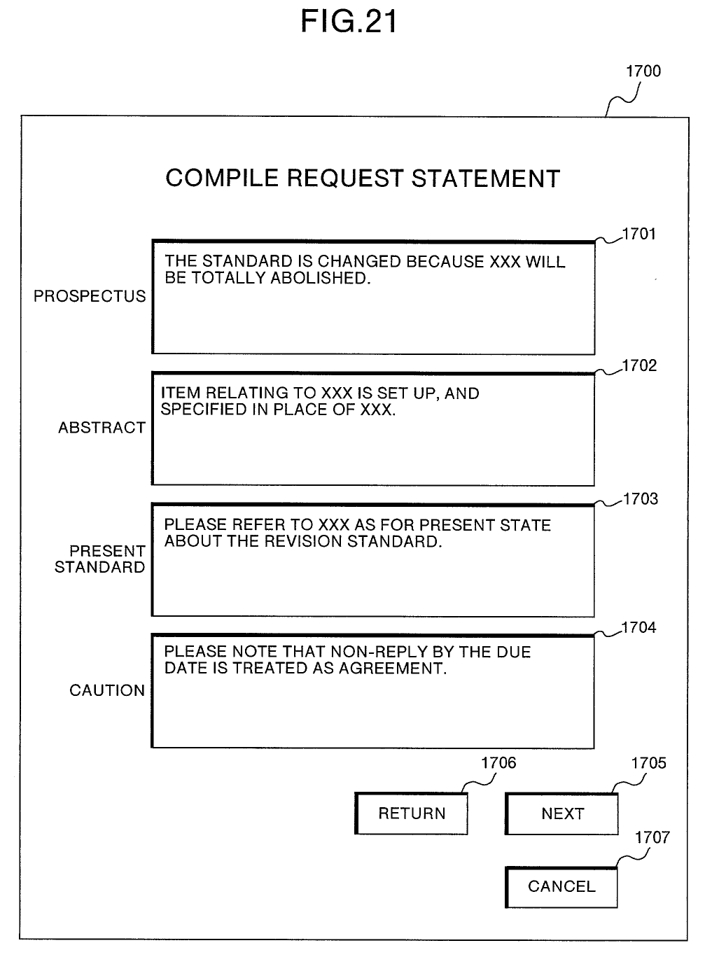

The text input column 1602 is a column for input of text in the request mail. The closing day select button 1603 is a button for selecting the reply closing data (reply limit term) of the document examination result. The next screen shift button 1604 is a button for shifting to next request statement compilation screen 1700 (see FIG. 21). The cancel button 1605 is a button for canceling the input data.

Back to FIG. 8, at step SD2, the main controller 220 judges if the cancel button 1605 is pressed or not. If judged Yes, at step SD4, the main controller 220 resets the input data. In this case, suppose it is judged No at step SD2. At step SD3, the main controller 220 judges if the next screen shift button 1604 is pressed or not, and it is judged No in this case. Thereafter, the judgment at step SD2 and step SD3 is repeated.

The user (examination requester) enters the case name and text in the case name input column 1601 and text input column 1602, selects the closing day by the closing day select button 1603, and presses the next screen shift button 1604. As a result, the main controller 220 judges Yes at step SD3.

At step SD5, the main controller 220 shows a request statement compilation screen 1700 shown in FIG. 21 on the display (not shown) of the examination requester side client 100₁. The request statement compilation screen 1700 is a screen for compiling the statement about the examination request (prospectus and abstract of establishment, present standard, caution). This request statement compilation screen 1700 includes a prospectus input column 1701, an abstract input column 1702, a present standard input column 1703, a caution input column 1704, a next screen shift button 1705, a previous screen shift button 1706, and a cancel button 1707.

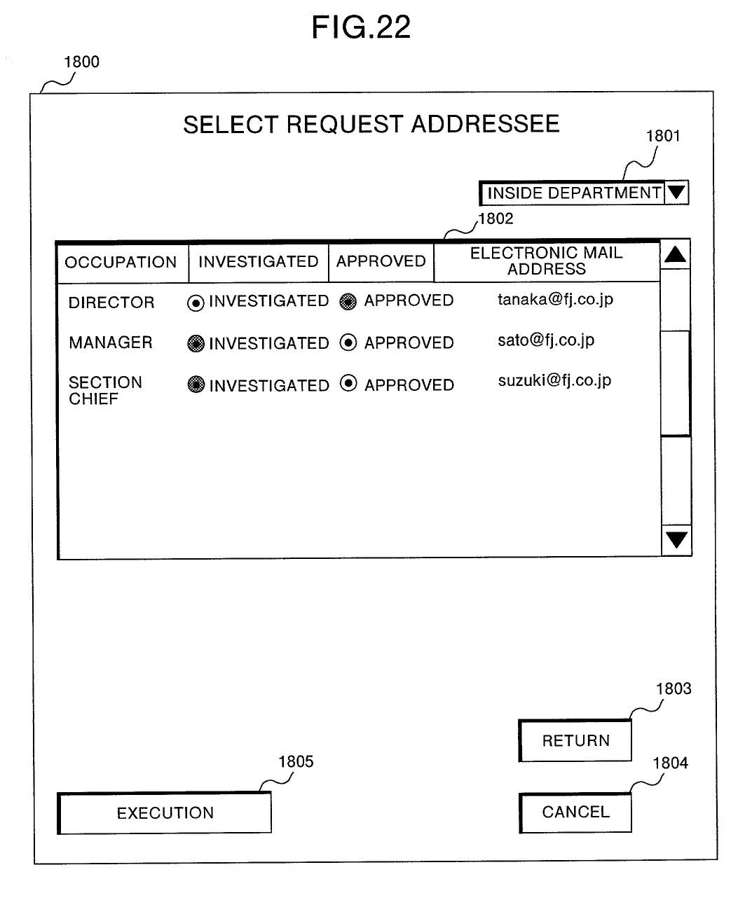

The prospectus input column 1701 is a column for input of the prospectus of establishment. The abstract input column 1702 is a column for input of abstract of the establishment. The present standard input column 1703 is a column for input of present standard. The caution input column 1704 is a column for input of caution items. The next screen shift button 1705 is a button for shifting to next examination requester select screen 1800 (see FIG. 22). The previous screen shift button 1706 is a button for shifting to the previous request mail compilation screen 1600 (see FIG. 20). The cancel button 1707 is a button for canceling the input data.

Back to FIG. 8, at step SD6, the main controller 220 judges if the previous screen shift button 1706 is pressed or not, and when judged Yes, the request mail compilation screen 1600 (see FIG. 20) is displayed at step SD1. In this case, if judged No at step SD6, going to step SD7, the main controller 220 judges if the cancel button 1707 is pressed or not.

If judged Yes, at step SD9, the main controller 220 resets the input data. In this case, if judged No at step SD7, going to step SD8, the main controller 220 judges if the next screen shift button 1705 is pressed or not, and it is judged No in this case, and the judgment after step SD6 is repeated.

The user (examination requester) enters the prospectus, others and caution in the prospectus input column 1701 to caution input column 1704, and presses the next screen shift button 1705. As a result, the main controller 220 judges Yes at step SD8. At step SD10, the main controller 220 shows an examination request addressee select screen 1800 shown in FIG. 22 on the display (not shown) of the examination requester side client 100₁.

This examination request addressee select screen 1800 is a screen for selecting the request addressee of investigation or request addressee of document examination. The examination request addressee select screen 1800 includes an inside/outside department select button 1801, an inside department request addressee list display column 1802, a previous screen shift button 1803, a cancel button 1804, and an execution button 1805.

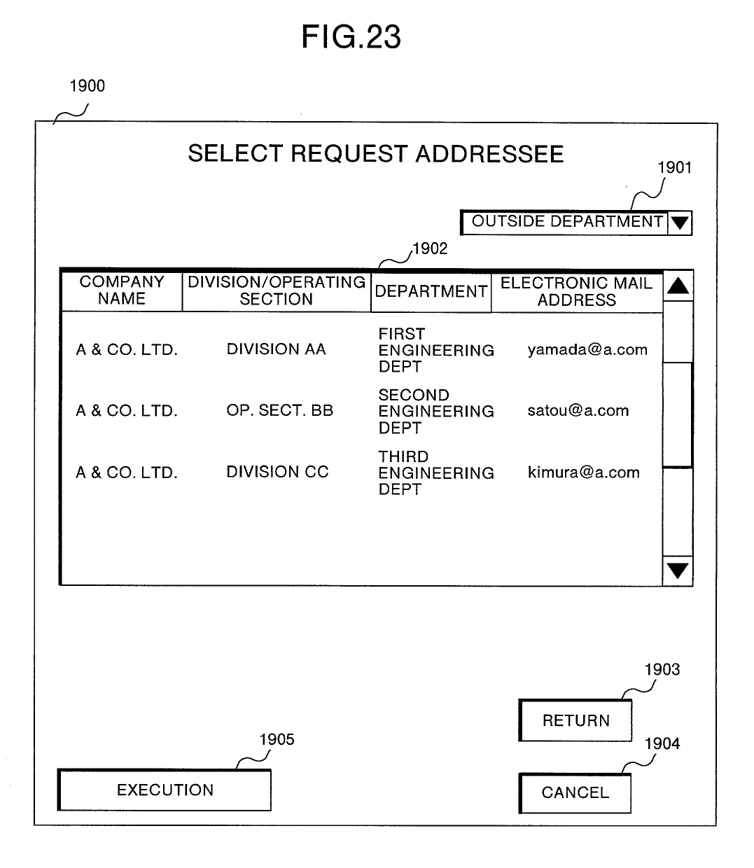

The inside/outside department select button 1801 is a button for selecting inside or outside of department as the examiner. When the outside is selected, the examination request addressee select screen 1800 is displayed. On the other hand, when the outside is selected, an outside department request addressee select screen 1900 shown in FIG. 23 is displayed.

The inside department examination request addressee list display column 1802 displays a list of information of request addressees in the department. This inside department examination request addressee select screen 1802 comprises fields of position name, investigator, approver, and electronic mail address. The position name is the information about the occupational position of the investigator or approver of the request addressee (synonymous with examiner or replier). The investigator and approver are selected by the radio button. The electronic mail address is the address of the request mail.

The previous screen shift button 1803 is a button for shifting to the previous request statement compilation screen 1700 (see FIG. 21). The cancel button 1804 is a button for canceling the selection result in the inside department examination request addressee list display column 1802. The execution button 1805 is a button for executing transmission of request mail and others on the basis of the selection result in the inside department examination request addressee list display column 1802.

Back to FIG. 8, at step SD11, the main controller 220 judges if the user (examination requester) has selected the outside department or not by the inside/outside department select button 1801, and it is judged No in this case. At step SD13, the main controller 220 judges if the previous screen shift button 1803 is pressed or not. When it is judged Yes, the main controller 220 executes the process after step SD5.

In this case, if it is judged No at step SD13, going to step SD14, the main controller 220 judges if the cancel button 1804 is pressed or not. When it is judged Yes, at step SD16, the main controller 220 resets the selection result in the inside department request addressee list display column 1802. In this case, it is judged No at step SD14.

At step SD15, the main controller 220 judges if the execution button 1805 is pressed or not, and it is judged No in this case, and the judgment after step SD13 is repeated. The user selects the request addressee from the inside department request addressee list display column 1802, and selects investigation and approval. Then the user presses the execution button 1805. As a result, the main controller 2320 judges Yes at step SD15.

At step SD17, the main controller 220 converts the information relating to the request mail (standard number, request date and time, version number, case name, text, closing day, request statement, request addressee, etc.) into an XML format by attaching an XML tag to each phrase. At SD18, the main controller 220 stores the XML formatted information in the XML database 400.

At step SD19, the main controller 220 instructs a mail controller 230 to transmit the request mail to the electronic mail address of the investigator selected on the examination request addressee select screen 1800 shown in FIG. 22. As a result, the investigator recognizes the request of investigation of the examination document by this request mail.

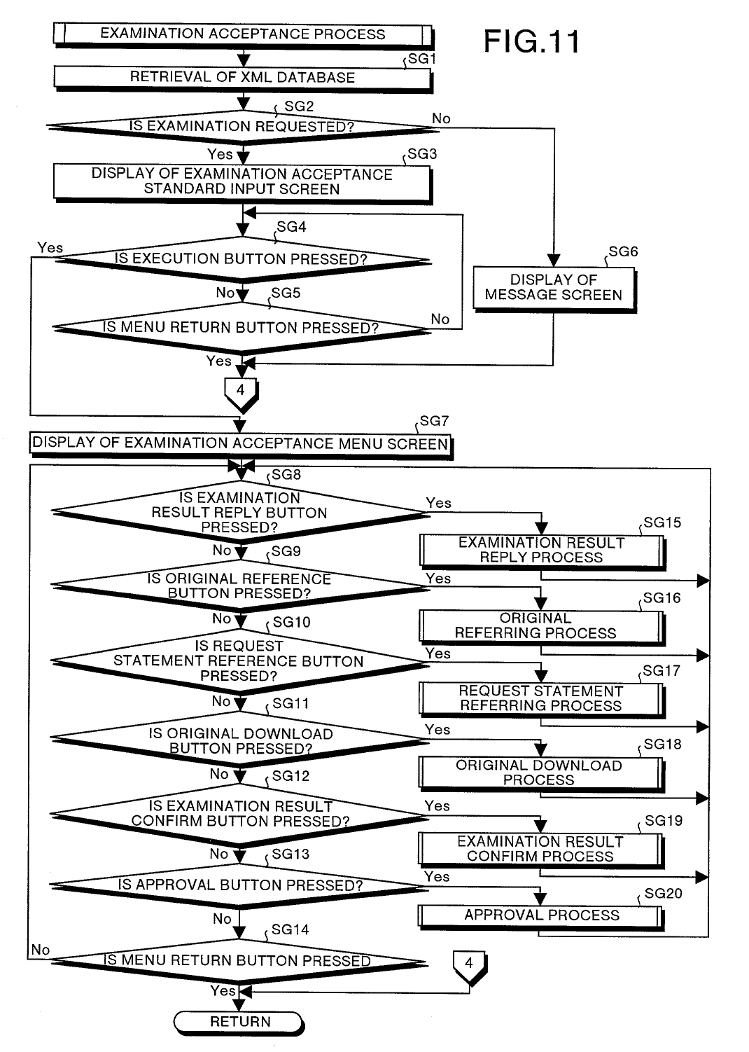

The investigator manipulates the investigator side client 130, and accesses the server 200. After the same operation as mentioned above, the investigator presses the original reference button 1502 of the examination request menu screen 1500. Consequently, the main controller 220 judges Yes at step SC6 showing FIG. 7, and original referring process is executed at step SC14. In this original referring process, the investigator refers to the original (examination document) of investigation request by using the standard number as the key, and investigates. The detail of the original referring process is explained later at step SG16 (see FIG. 11).

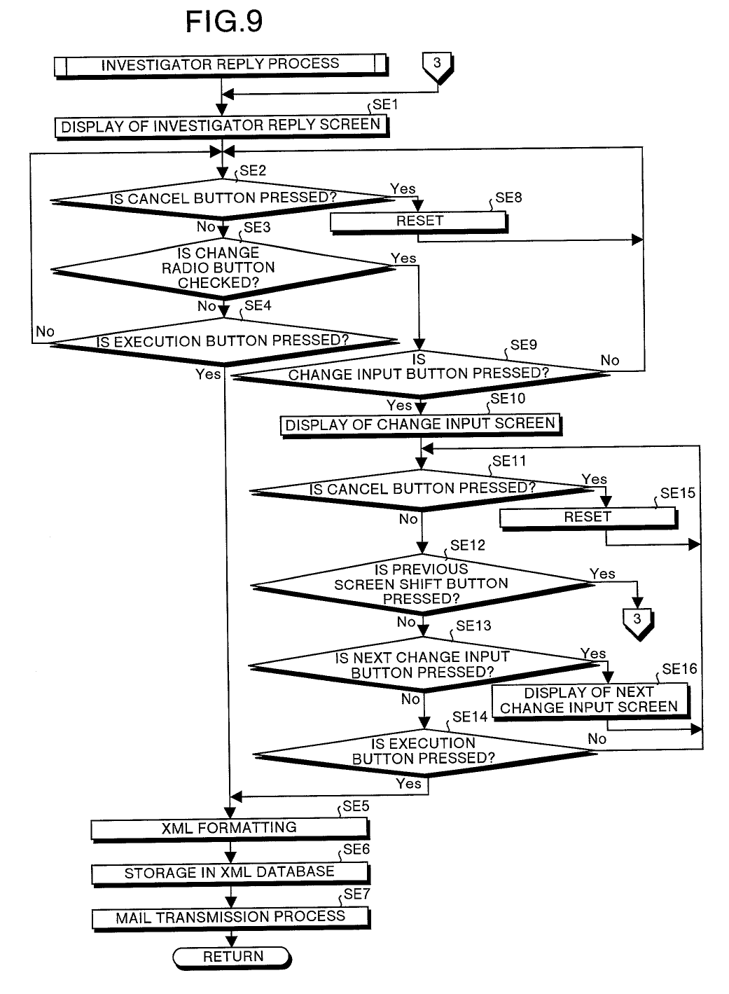

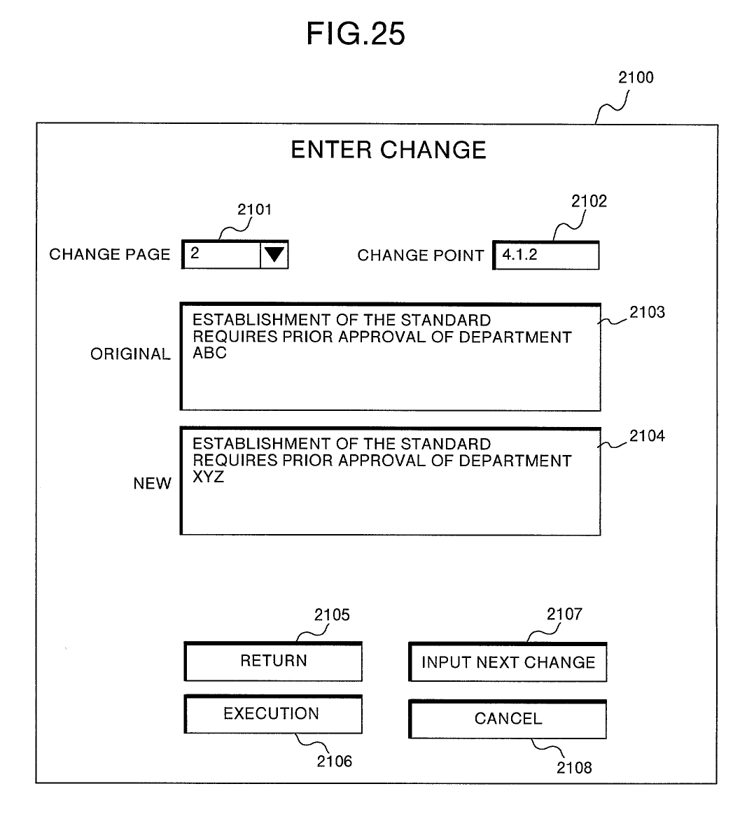

The investigator, in order to reply the investigation result, presses the investigator reply button 1506 shown in FIG. 19. As a result, the main controller 220 judges Yes at step SC10 shown in FIG. 7. At step SC18, the main controller 220 executes an investigator reply process. Specifically, at step SE1 shown in FIG. 9, the main controller 220 shows the investigator reply screen 2000 shown in FIG. 25 on the display (not shown) of the investigator side client 130.

This investigator reply screen 2000 is a screen for replying the investigation result by the investigator (change or no change). The investigator reply screen 2000 includes a no change radio button 2001 selected when there is no change in the investigation result, a change radio button 2002 selected when there is change in the investigation result, an execution button 2003 for executing the process of the reply according to the selection, a cancel button 2004, and a change input button 2005 for input of change.

Back to FIG. 9, at step SE2, the main controller 220 judges if the cancel button 2004 is pressed or not. If judged Yes, at step SE8, the main controller 220 resets the selection result by the no change radio button 2001 or change radio button 2002. In this case, it is judged No at step SE2.

At step SE3, the main controller 220 judges if the change radio button 2002 is checked or not, and it is judged No in this case. At step SE4, the main controller 220 judges if the execution button 2003 is pressed or not, and it is judged No in this case, and the judgment after step SE2 is repeated.

Herein, if there is no change in the investigation result, that is, nothing is changed in the examination document, the investigator checks the no change radio button 2001, and presses the execution button 2003. As a result, the main controller 220 judges Yes at step SE4.

At step SE5, the main controller 220 converts the investigation result and text into an XML format by attaching an XML tag to each phrase. At step SE6, the main controller 220 stores the XML formatted information in the XML database 400. At step SE7, the main controller 220 instructs the mail controller 230 to transmit the investigation result to, for example, the examiner/replier side client 120₁ by mail.

On the other hand, if judged Yes at step SE3, that is, there is a change in the examination document to be investigated, at step SE9, the main controller 220 judges if the change input button 2005 is pressed or not, and it is judged No in this case, and the judgment after step SE2 is repeated.

When the change input button 2005 is pressed by the investigator, the main controller 220 judges Yes at step SE9. At step SE10, the main controller 220 shows the change input screen 2100 shown in FIG. 25 on the display (not shown) of the investigator side client 130.

The change input screen 2100 is a screen for input of change. The change input screen 2100 includes a change page select button 2101 for selecting the changing page of the examination document, a change position input column 2102 for input of changing position, an original input column 2103 for input of the original before change, a change input column 2104 for input of change corresponding to the original, a previous screen shift button 2105, an execution button 2106, a next change input button 2107, and a cancel button 2108.

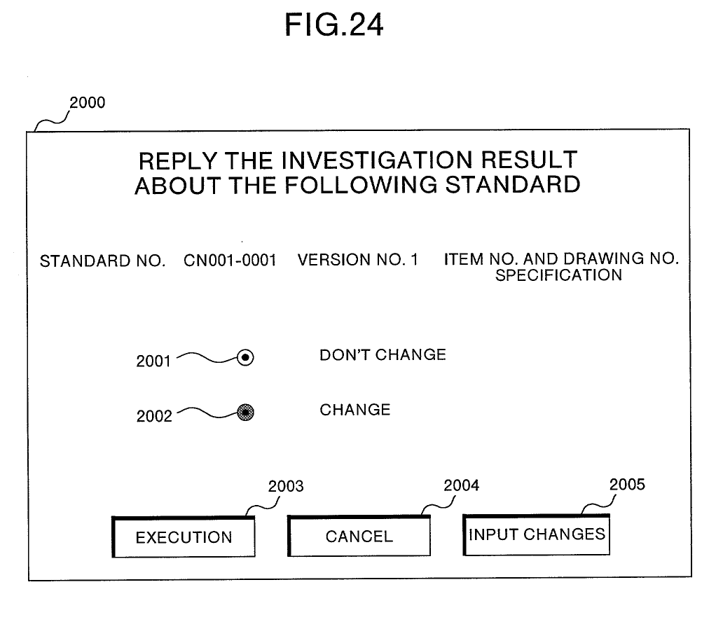

Back to FIG. 9, at step SE11, the main controller 220 judges if the cancel button 2108 is pressed or not. If judged Yes, at step SE15, the main controller 220 resets the input data. On the other hand, if judged No at step SE11, going to step SE12, the main controller 220 judges if the previous screen shift button 2105 is pressed or not. If judged Yes, at step SE1, the main controller 220 displays the investigator reply screen 2000 (see FIG. 24).

If judged No at step SE11, going to step SE13, the main controller 220 judges if the next change input button 2107 is pressed or not, and it is judged No in this case. At step SE14, the main controller 220 judges if the execution button 2106 is pressed or not, and it is judged No in this case, and the judgment after step SE11 is repeated.

The investigator selects the changing page by the change page select button 2101, and enters the changing position in the change position input column 2102. Next, the investigator enters the original and the change in the original input column 2103 and change input column 2104, and presses the next change input button 2107 if there is a further position to be changed. As a result, at step SE16, the main controller 220 shows the change input screen not shown on the display (not shown) of the investigator side client 130. The investigator enters the next position to be changed.

When the execution button 2106 shown in FIG. 25 is pressed, the main controller 220 judges Yes at step SE14. At step SE5, the main controller 220 converts the investigation result, changing page, changing position, original, and the detail of change into an XML format by attaching an XML tag to each phrase.

At step SE6, the main controller 220 stores the XML formatted information in the XML database 400. At step SE7, the main controller 220 instructs the mail controller 230 to transmit the information of investigation result, changing page, changing position, original, and the detail of change to, for example, the examination requester side client 100₁ by mail. Accordingly, the examination requester changes the examination document.

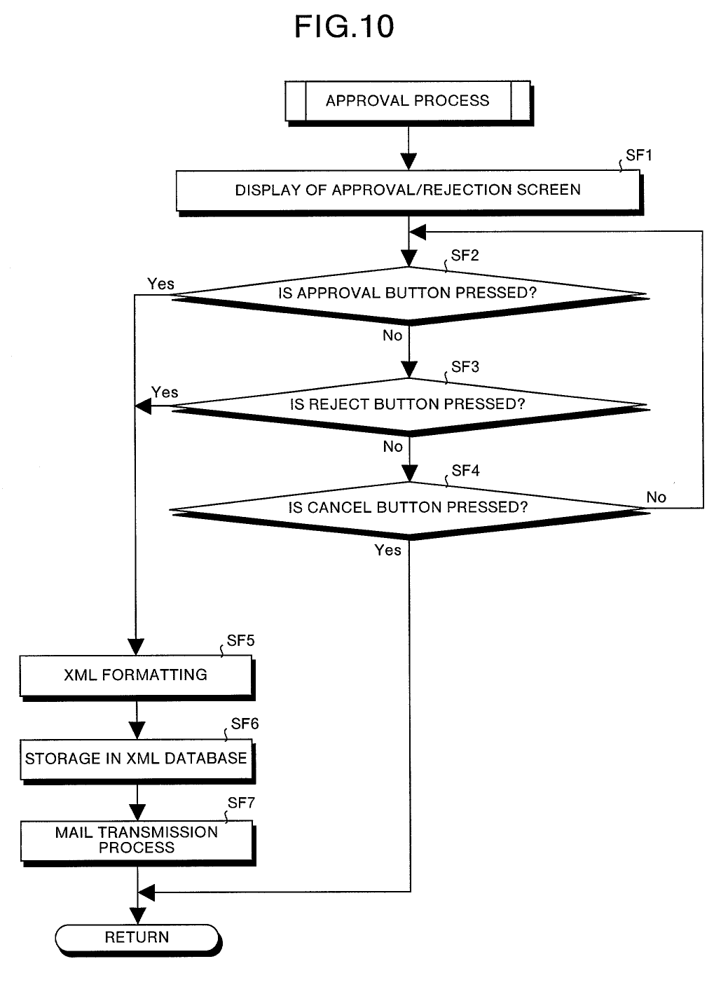

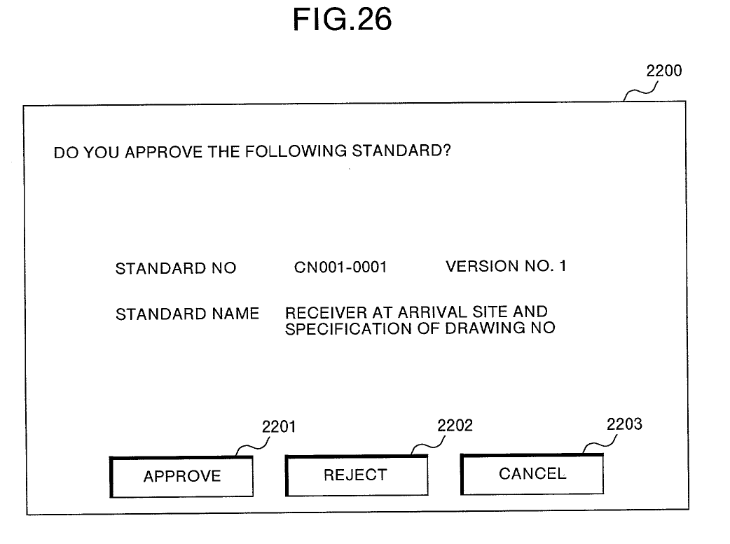

When the approval button 1507 shown in FIG. 19 is pressed, the main controller 220 judges Yes at step SC11 shown in FIG. 7. At step SC19, the main controller 220 executes the approval process about examination request. Specifically, at step SF1 shown in FIG. 10, the main controller 220 shows an approval/rejection screen 220 shown in FIG. 26 on the display (not shown) of the examination requester side client 100₁.

In the case of examination request, the approval/rejection screen 2200 is a screen for selecting whether to approve or to reject the examination request. In the approval/rejection screen 2200, the standard name and standard number relating to the examination document are displayed, and an approval button 2201, a reject button 2202, and a cancel button 2203 are provided.

Back to FIG. 10, at step SF2, the main controller 220 judges if the approval button 2201 is pressed or not, and it is judged No in this case. At step SF3, the main controller 220 judges if the reject button 2202 is pressed or not, and it is judged No in this case. At step SF4, the main controller 220 judges if the cancel button 2203 is pressed or not, and it is judged No in this case. Thereafter, the main controller 220 repeats the judgment after step SF2.

Herein, when approving the examination request, the approval button 2201 is pressed. As a result, the main controller 220 judges Yes at step SF2. At step SF5, the main controller 220 converts the approval notice information, and the information for specifying the examination document such as standard number and standard name into an XML format by attaching an XML tag to each phrase. At step SF6, the main controller 220 stores the XML formatted information in the XML database 400. At step SF, the main controller 220 instructs the mail controller 230 to transmit the information to, for example, the examiner/replier side client 120, through the Internet 110 as the examination request approval mail. As a result, the examiner or replier recognizes that the document examination is requested.

On the other hand, when rejecting the examination request, the reject button 2202 is pressed. As a result, the main controller 220 judges Yes at step SF3. At step SF5, the main controller 220 converts the rejection notice information, and the information for specifying the rejected document such as standard number and standard name into an XML format by attaching an XML tag to each phrase.

At step SF6, the main controller 220 stores the XML formatted information in the XML database 400. At step SF, the main controller 220 instructs the mail controller 230 to transmit the information to the examination requester side client 100₁ and investigator side client 130 through the Internet 110 as the examination request rejection mail. As a result, the examination requester and investigator recognize that the document examination request is rejected. The examination requester corrects the examination document, and requests the examination again.

When the outside is selected in the inside/outside department select button 1801 shown in FIG. 22, the main controller 220 judges Yes at step SD11 shown in FIG. 8. At step SD12, the main controller 220 shows the outside department request addressee select screen 1900 shown in FIG. 23 on the display (not shown) on the examination requester side client 100₁.

This outside department request addressee select screen 1900 is a screen for selecting the investigation request addressee outside of the department or the request addressee of document examination. The outside department request addressee select screen 1900 includes an inside/outside department select button 1901, an outside department request addressee list display column 1902, a previous screen shift button 1903, a cancel button 1904, and an execution button 1905.

The inside/outside department select button 1901 is a button for selecting inside or outside of department as the request addressee. In this case, since the outside is selected, the outside is displayed in the inside/outside department select button 1901. The outside department request addressee list display column 1902 displays a list of information of request addressees of outside of the department.

This outside department request addressee list display column 1902 comprises fields of company name, division/operating section, department in charge, and electronic mail address. The company name, division/operating section, and department in charge are the information about the request addressee of the document examination, and the electronic mail address is the address of the request mail.

When the user selects the request addressee from the inside department request addressee list display column 1802 shown in FIG. 22 and selects investigation, and presses the execution button 1805, the main controller judges Yes at step SD15.

At SD17, the main controller 220 converts the information about request mail (standard number, request date and time, version number, case name, text, closing day, request statement, request addressee, etc.) into an XML format by attaching an XML tag to each phrase. At step SD18, the main controller 220 stores the XML formatted information in the XML database 400. At step SD19, the main controller 220 instructs the mail controller 230 to transmit the request mail to the request addressee (for example, the electronic mail address corresponding to the investigator side client 130). As a result, the investigator, receiving this request mail, recognizes that the investigation of the examination document is requested, and replies the investigation result.

When the examiner or replier accepts the examination request, the procedure is as follows. When accepting the examination request, the examiner or replier accesses the server 200 by manipulating, for example, the examiner/replier side client 120₁. After the user authentication and other operation as mentioned above, the examiner or replier presses the examination acceptance button 1103 shown in FIG. 15. As a result, the main controller 220 judges Yes at step SA8 shown in FIG. 5. At step SA13, the examination acceptance process is executed.

Specifically, at step SG1 shown in FIG. 11, the XML database 400 is retrieved. That is, the main controller 220, using the user ID of the examiner or replier as the key, refers to the user information meta information 310 shown in FIG. 2A, and specifies the department code to which the examiner or replier belongs. Consequently, from the department code and the department information meta information 350 (see FIG. 3A), the department name to which the examiner or replier belongs.

Using the department name as the key, the main controller 220 acquires the information of examination document requested to be examined to the department from the XML database 400, and acquires the standard number and standard name corresponding to the examination document from this information. At step SG2, the main controller 220 judges if examination is requested or not, and when it is judged No, an error message screen is displayed at step SG6.

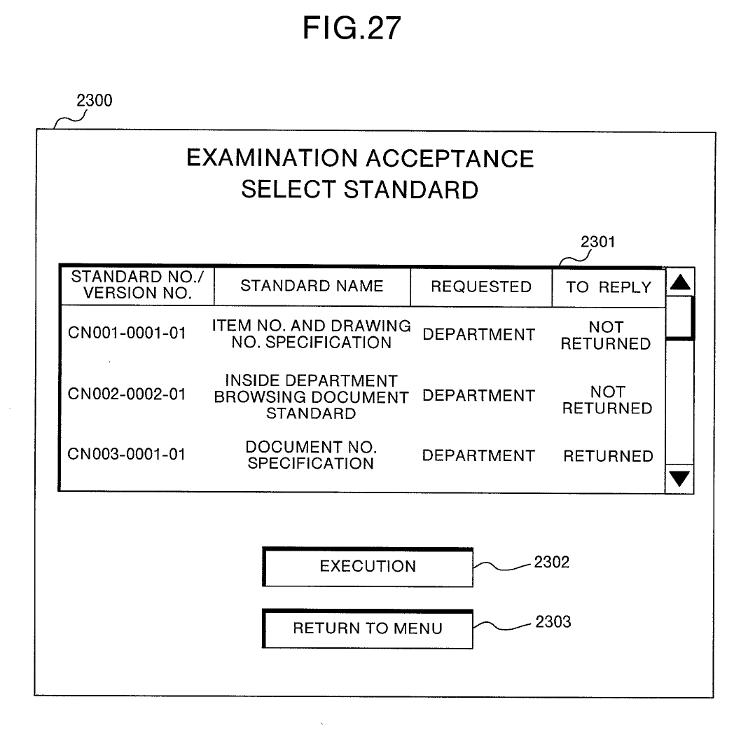

On the other hand, if judged Yes at step SG2, going to step SG3, the main controller 220 shows a standard selection screen 2300 shown in FIG. 27 on the display (not shown) of the examiner/replier side client 120₁. This standard selection screen 2300 is a screen for selecting the one to be examined from the list of standards (examination documents) requested to be examined by the department from the examination requester.

The standard selection screen 2300 includes a standard list display column 2301 for displaying a list of the standards (examination documents), an execution button 2302, A and a menu return button 2303. The standard list display column 2301 comprises fields of standard number/version number, standard name, request addressee, and reply status.

Back to FIG. 11, at step SG4, the main controller 220 judges if the execution button 2302 is pressed or not, and it is judged No in this case. At step SG5, the main controller 220 judges if the menu return button 2303 is pressed or not, and it is judged No in this case, and the judgment after step SG4 is repeated.

The examiner or replier selects the object of examination (for example, the first record) from the standard list display column 2301 shown in FIG. 27, and presses the execution button 2302. As a result, the main controller 220 judges Yes at step SG4. At step SG7, the main controller 220 shows an examination acceptance menu screen 2400 shown in FIG. 24 on the display (not shown) of the examiner/replier side client 120₁.

The examination acceptance menu screen 2400 is a screen for selecting any process of examination result reply process, original referring process, request statement referring process, original download process, examination result confirm process, approval process, and menu screen return process. The examination acceptance menu screen 2400 also includes an examination result reply button 2401 for selecting the examination result reply process.

Further, the examination acceptance menu screen 2400 includes an original reference button 2402 for selecting the original referring process, a request statement reference button 2403 for selecting the request statement referring process, an original download button 2404 for selecting the original download process, an examination result confirm button 2405 for selecting the original result confirm process, and a menu return button 2407 for returning toe the top menu screen 1100.

Herein, the examination result reply process is a process for replying the result of examination of the examination document requested from the examination requester. The original referring process is a process for referring to the uploaded original file (examination document). The request statement referring process is a process for referring to the request statement (request mail).

The original download process is a process for downloading the original file uploaded on the server 200 to, for example, the examiner/replier side client 120₁ through the Internet 110. The examination result confirm process is a process for confirming the examination result of the examination document. The approval process is a process for approving (or rejecting) the examination request.

Back to FIG. 11, at step SG8, the main controller 220 judges if the examination result reply button 2401 is pressed or not, and it is judged No in this case. At step SG9, the main controller 220 judges if the original reference button 2402 is pressed or not, and it is judged No in this case. At step SG10, the main controller 220 judges if the request statement reference button 2403 is pressed or not, and it is judged No in this case.

At step SG11, the main controller 220 judges if the original download button 2404 is pressed or not, and it is judged No in this case. At step SG12, the main controller 220 judges if the examination result confirm button 2405 is pressed or not, and it is judged No in this case.

At step SG13, the main controller 220 judges if the approval button 2406 is pressed or not, and it is judged No in this case. At step SG14, the main controller 220 judges if the menu return button 2407 is pressed or not, and it is judged No in this case. Thereafter, the main controller 220 repeats the judgment from step SG8 to step SG14.

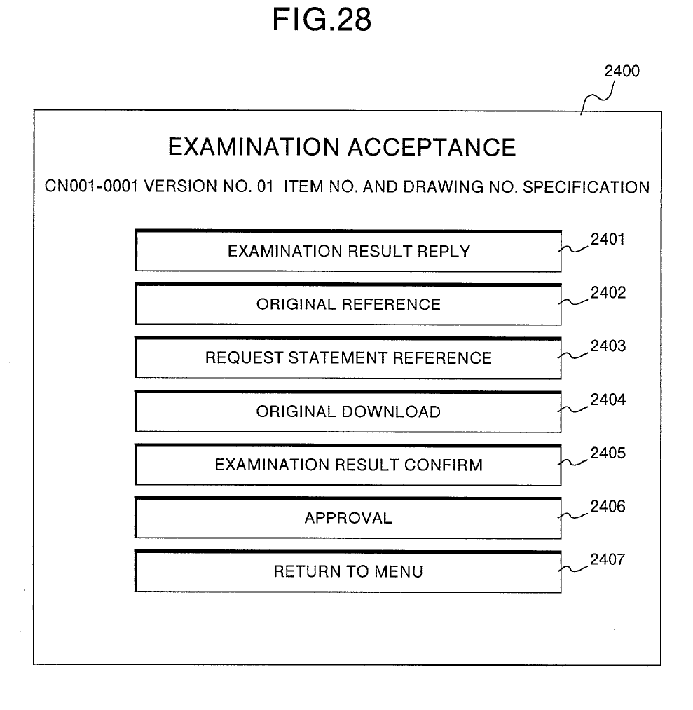

When the examiner or replier presses the request statement reference button 2403 shown in FIG. 28, the main controller 220 judges Yes at step SG10 shown in FIG. 11. At step SG17, the main controller 220 executes the request statement referring process.

Specifically, the main controller 220 acquires the information of request statement of examination request corresponding to the standard number, from the XML database 400, using the standard number of the first record selected on the standard selection screen 230 shown in FIG. 27 as the key. Herein, the main controller 220 refers to the department information meta information 350 (see FIG. 3A) and confirms the granted status of the authority of the department to which the examiner or replier belongs, and matches with the standard importance degree of the examination document corresponding to the request statement acquired from the XML database 400.

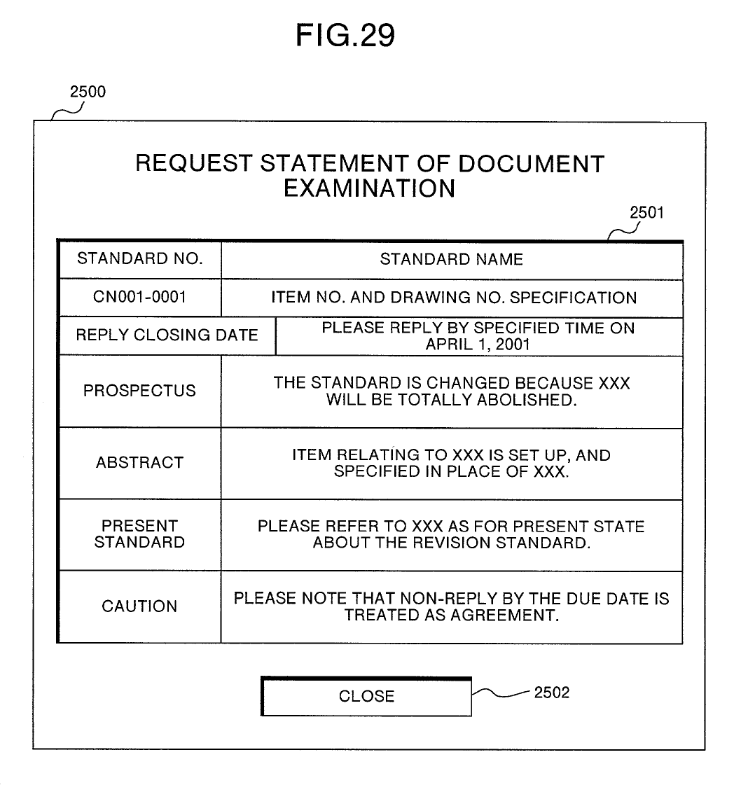

Next, the main controller 220 judges approval or rejection of reference of request statement about the examination document, and executes the following process only when approved. When the reference is approved, the main controller 220 shows a request statement reference screen 2500 shown in FIG. 29 on the display (not shown) of the examiner/replier side client 120₁. If reference is rejected, the examiner or replier cannot refer to the request statement.

The request statement reference screen 2500 is a screen for displaying the information of request statement acquired from the XML database 400. The request statement reference screen 2500 includes a request statement display column 2501 for displaying the request statement, and a close button 2502. This request statement is compiled by the examination request on the request statement compilation screen 1700 shown in FIG. 21.

The examiner or replier refers to the request statement reference screen 2500, and understands the detail of the examination request (standard number, . . . , reply closing date, prospectus, . . . , caution). At step SC15 shown in FIG. 7, the request statement is referred to by the examination requester (or investigator) same as at step SG17.

Now, the examiner or replier presses the original reference button 2402 shown in FIG. 28 in order to refer to the original as the actual examination document. As a result, the main controller 220 judges Yes at step SG9 shown in FIG. 11. At step SG16, the main controller 220 executes the original referring process. Specifically, using the standard number of the first record selected on the standard selection screen 2300 shown in FIG. 27 as the key, the original file (examination document) corresponding to the standard number is acquired from the XML database 400.

Herein, the main controller 220 refers to the department information meta information (see FIG. 3A), and confirms the granted status of the authority of the department to which the examiner or replier belongs, and matches with the standard importance degree of the examination document corresponding to the request statement acquired from the XML database 400.

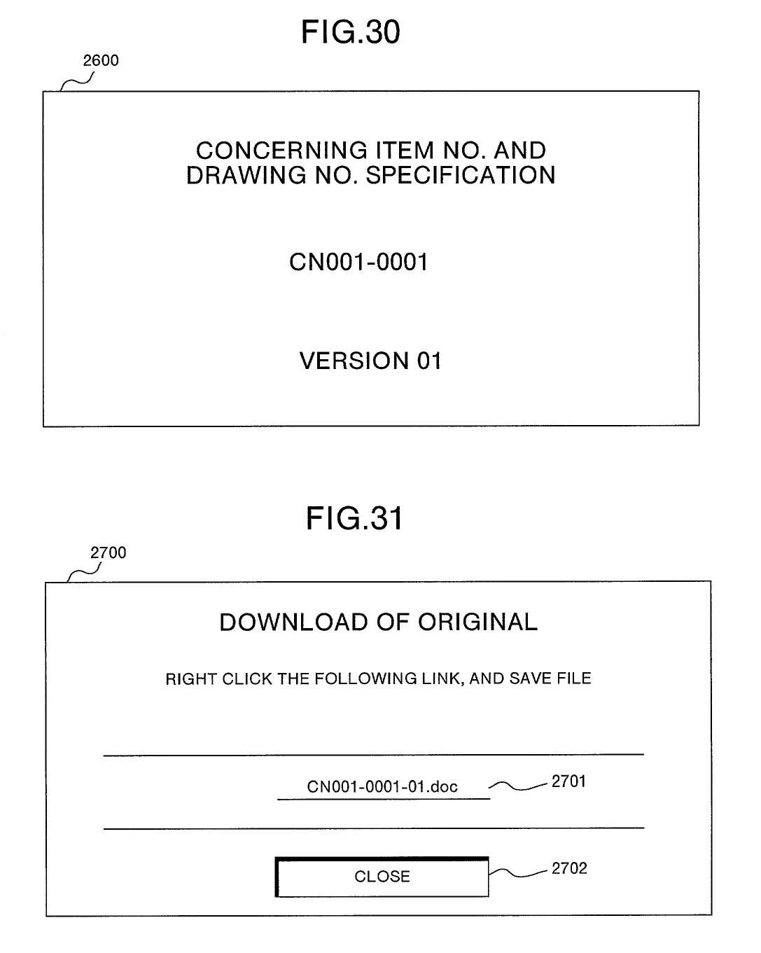

Consequently, the main controller 220 judges approval or rejection of original file reference relating to the examination document, and executes the process only when approved. When the reference is approved, the main controller 220 shows an original reference screen 2600 shown in FIG. 30 on the display (not shown) of the examiner/replier side client 1201.

As a result, the examiner or replier understands the content of the examination document as the object of examination from the original reference screen 2600, and starts examination. If reference is rejected, the examiner or replier cannot refer to the original file. Herein, also at step SC14 shown in FIG. 7, same as at step SG16, the examination requester (or investigator) refers to the original.

The examiner or replier presses the original download button 2404 shown in FIG. 28 in order to download the original file as the actual examination document. As a result, the main controller 220 judges Yes at step SG11 in FIG. 11. At step SG18, the main controller 220 executes the original download process. Specifically, using the standard number of the first record selected on the standard select screen 2300 shown in FIG. 27 as the key, the original file (examination document) corresponding to the standard number is acquired from the XML database 400.

Herein, the main controller 220 refers to the department information meta information (see FIG. 3A), and checks the granted status of the authority of the department to which the examiner or replier belongs, and matches with the standard importance degree of the examination document corresponding to the original file acquired from the XML database 400.

The main controller 220 judges approval or rejection of download of the original file relating to the examination document, and executes the following process only when approved. When downloading is approved, the main controller 220 shows an original download screen 2700 shown in FIG. 31 on the display (not shown) of the examiner/replier side client 120₁.

This original download screen 2700 is a screen for downloading the original file stored in the XML database 400 to the examiner/replier side client 120₁. The original download screen 2700 includes an original file link button 2701 for linking to the storage site of the original file, and a close button 2702.

When the examiner or replier presses the original file link button 2701, the main controller 220 downloads the original file to the examiner/replier side client 120₁. As a result, in the examiner/replier side client 120₁, the downloaded original file is opened, and the content of the examination document as the object of examination is understood and the examination is started.

Herein, if downloading is rejected, the examiner/replier cannot download the original file. Meanwhile, at step SC16 shown in FIG. 7, same as at step SG18, downloading of the original file is executed by the examination requester (or investigator).

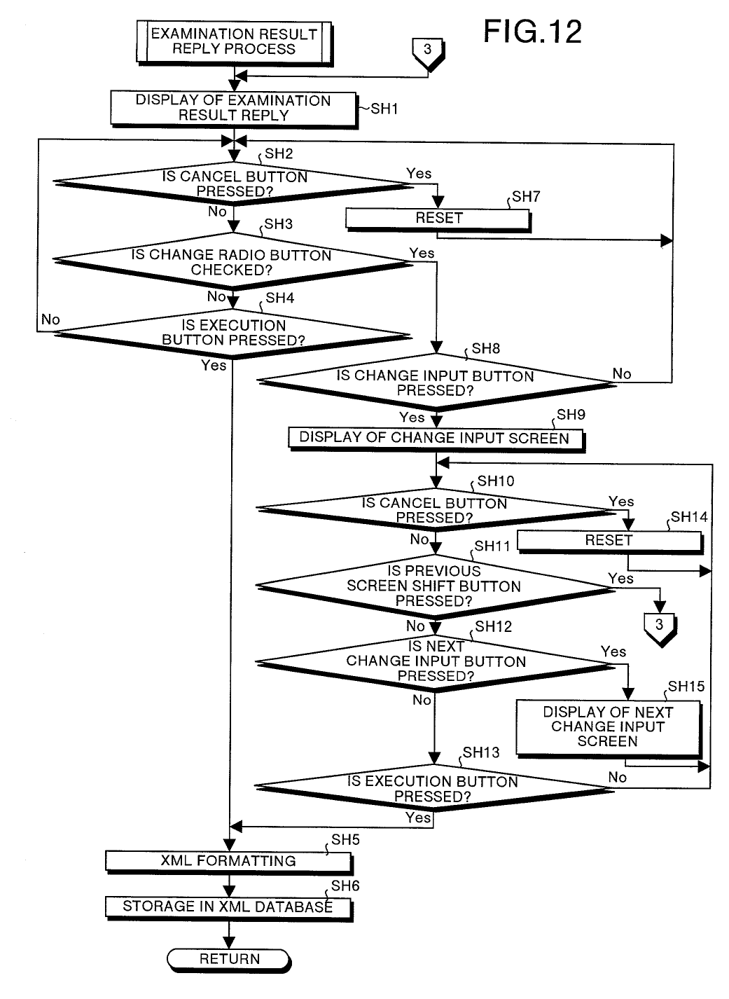

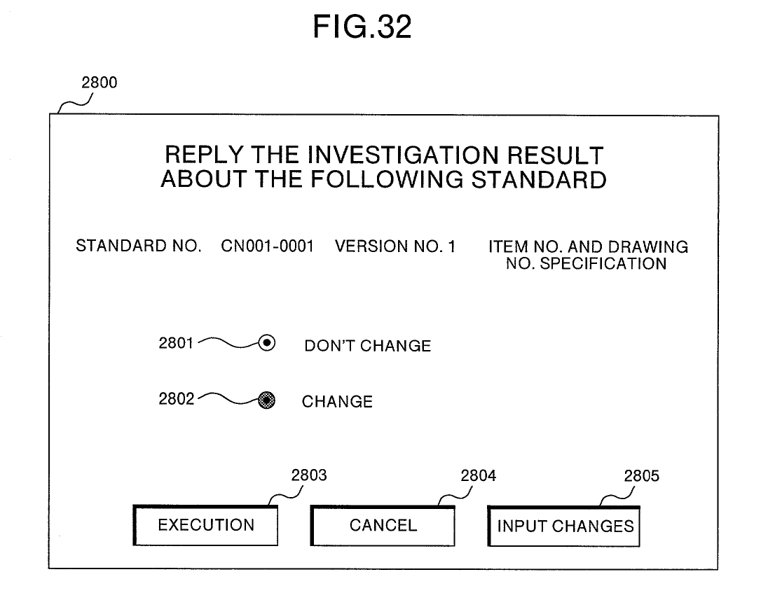

The examiner or replier presses the examination result reply button 2401 shown in FIG. 28 in order to reply the examination result relating to the examination document requested for examination. Consequently, the main controller 220 judges Yes at step SG8 shown in FIG. 11. At step SG15, the main controller 220 executes the examination result reply process. Specifically, at step SH1 shown in FIG. 12, the main controller 220 shows an examination result reply screen 2800 shown in FIG. 32 on the display (not shown) of the examiner/replier side client 120₁.

This examination result reply screen 2800 is a screen for replying the examination result (change or no change). The examination result reply screen 2800 includes a no change radio button 2801 selected when there is no change in the examination result, a change radio button 2802 selected when there is change in the examination result, an execution button 2803 for executing the process of the reply according to the selection, a cancel button 2804, and a change input button 2805 for input of change.

Back to FIG. 12, at step SH2, the main controller 220 judges if the cancel button 2804 is pressed or not. If judged Yes, at step SH7, the main controller 220 resets the selection result by the no change radio button 2801 or change radio button 2802. In this case, it is judged No at step SH2.

At step SH3, the main controller 220 judges if the change radio button 2802 is checked or not, and it is judged No in this case. At step SH4, the main controller 220 judges if the execution button 2803 is pressed or not, and it is judged No in this case, and the judgment after step SH2 is repeated.

Herein, if there is no change in the examination result, that is, nothing is changed in the examination document, the examiner or replier checks the no change radio button 2801, and presses the execution button 2803. As a result, the main controller 220 judges Yes at step SH4. At step SH5, the main controller 220 converts the examination result and text into an XML format by attaching an XML tag to each phrase. At step SH6, the main controller 220 stores the XML formatted information in the XML database 400.

On the other hand, if judged Yes at step SH3, that is, there is a change in the examination document to be investigated, at step SH8, the main controller 220 judges if the change input button 2805 is pressed or not, and it is judged No in this case, and the judgment after step SH2 is repeated.

When the change input button 2805 is pressed by the investigator, the main controller 220 judges Yes at step SH8. At step SH9, the main controller 220 shows the change input screen 2100 shown in FIG. 25 on the display (not shown) of the examiner/replier side client 120₁.

The change input screen 2100 is a screen for input of change. The change input screen 2100 includes a change page select button 2101 for selecting the changing page of the examination document, a change position input column 2102 for input of changing position, an original input column 2103 for input of the original before change, a change input column 2104 for input of change corresponding to the original, a previous screen shift button 2105, an execution button 2106, a next change input button 2107, and a cancel button 2108.

Back to FIG. 12, at step SH10, the main controller 220 judges if the cancel button 2108 is pressed or not. If judged Yes, at step SH14, the input data is reset. On the other hand, if judged No at step 10, going to step SH11, the main controller 220 judges if the previous screen shift button 2105 is pressed or not, and if judged Yes, at step SH1, the examination result reply screen 2800 is displayed (see FIG. 32).

If judged No at step SH11, going to step SH12, the main controller 220 judges if the next change input button 2107 is pressed or not, and it is judged No in this case. At step SH13, the main controller 220 judges if the execution button 2106 is pressed or not, and it is judged No in this case, and the judgment after step SH10 is repeated.

The examiner or replier enters the original and the change in the original input column 2103 and change input column 2104, and presses the next change input button 2107 if there is a further position to be changed. As a result, at step SH12, the main controller 220 judges Yes. At step SH15, the main controller 220 shows the change input screen not shown on the display (not shown) of the examiner/repliers side client 120₁. The examiner or replier enters the next position to be changed.

When the execution button 2106 shown in FIG. 25 is pressed, the main controller 220 judges Yes at step SH13. At step SH5, the main controller 220 converts the examination result, changing page, changing position, original, and the detail of change into an XML format by attaching an XML tag to each phrase. At step SH6, the main controller 220 stores the XML formatted information in the XML database 400.

When the approval button 2406 shown in FIG. 28 is pressed, the main controller 220 judges Yes at step SG13 shown in FIG. 11. At step SG20, the main controller 220 executes the approval process about examination request. Specifically, at step SF1 shown in FIG. 10, the main controller 220 shows an approval/rejection screen 2200 shown in FIG. 26 on the display (not shown) of the examiner/replier side client 120₁.

In the case of examination request, the approval/rejection screen 2200 is a screen for selecting whether to approve or to reject the examination request. Back to FIG. 10, the main controller 220 repeats the judgment after step SF2 same as in the operation mentioned above.

Herein, when approving the examination request, the approval button 2201 is pressed. As a result, the main controller 220 judges Yes at step SF2. At step SF5, the main controller 220 converts the approval notice information, and the information for specifying the examination document such as standard number and standard name into an XML format by attaching an XML tag to each phrase. At step SF6, the main controller 220 stores the XML formatted information in the XML database 400.

At step SF, the main controller 220 stores the XML formatted information in the XML database 400. At step SF, the main controller 220 instructs the mail controller 230 to transmit the information to, for example, the examination requester side client 1101 at the examination requesting side through the Internet 110 as the examination request approval mail. As a result, the examination requester recognizes that the request of document examination is approved.

On the other hand, when rejecting the examination request, the reject button 2202 is pressed. As a result, the main controller 220 judges Yes at step SF3. At step SF5, the main controller 220 converts the rejection notice information, and the information for specifying the rejected document such as standard number and standard name into an XML format by attaching an XML tag to each phrase. At step SF6, the main controller 220 stores the XML formatted information in the XML database 400.

At step SF, the main controller 220 stores the XML formatted information in the XML database 400. At step SF, the main controller 220 instructs the mail controller 230 to transmit the information to the examiner/replier side client 120₁ through the Internet 110 as the examination request rejection mail. As a result, the examiner or replier recognizes that the document examination request is rejected. The examiner or replier corrects examines or replies again.

When the examiner or replier presses the examination result confirm button 2405 shown in FIG. 28, the main controller 220 judges Yes at step SG12 shown in FIG. 11. At step SG19, the main controller 220 executes the examination result confirm process.

Specifically, the main controller 220 acquires the information about examination result and unreplied list information, from the XML database 400, using the department to which the examiner or replier belongs as the key. Herein, the main controller 220 refers to the department information meta information 350 (see FIG. 3A), and confirms the granted status of the authority of the department to which the examiner or replier belongs, and matches with the standard importance degree of the examination document corresponding to the examination result acquired from the XML database 400.

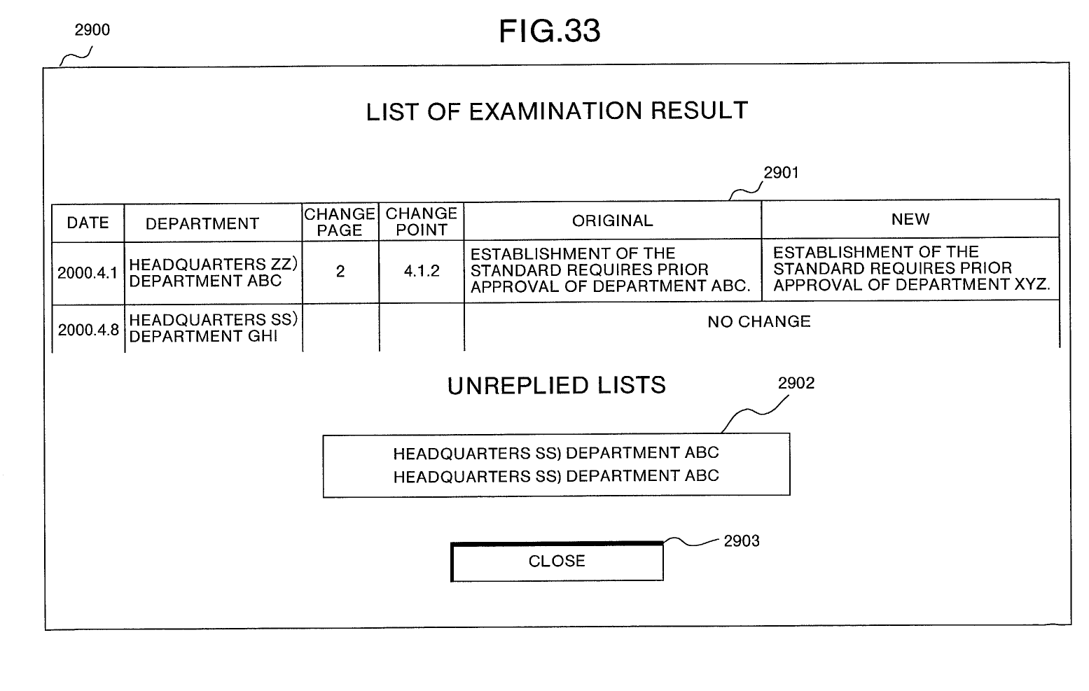

Next, the main controller 220 judges approval or rejection of confirmation of examination result about the examination document, and executes the following process only when approved. When the confirmation is approved, the main controller 220 shows an examination result reference screen 2900 shown in FIG. 33 on the display (not shown) of the examiner/replier side client 120₁. If confirmation is rejected, the examiner or replier cannot refer to the examination result.

The examination result reference screen 2900 is a screen for displaying the examination result list and unreplied list information acquired from the XML database 400. The examination result reference screen 2900 includes an examination result list display column 2901 for displaying the examination result list, an unreplied list display column 2902 for displaying an unreplied list, and a close button 2903. Also at step SC17 shown in FIG. 7, same as at step SG19, the examination result is confirmed by the examination requester (or investigator).

Management of user information of the document examination system is explained below. When the system manager presses a system management button 104 shown in FIG. 15, the main controller 220 judges Yes at step SA9 shown in FIG. 5. At step SA14, the main controller 220 executes system management process.

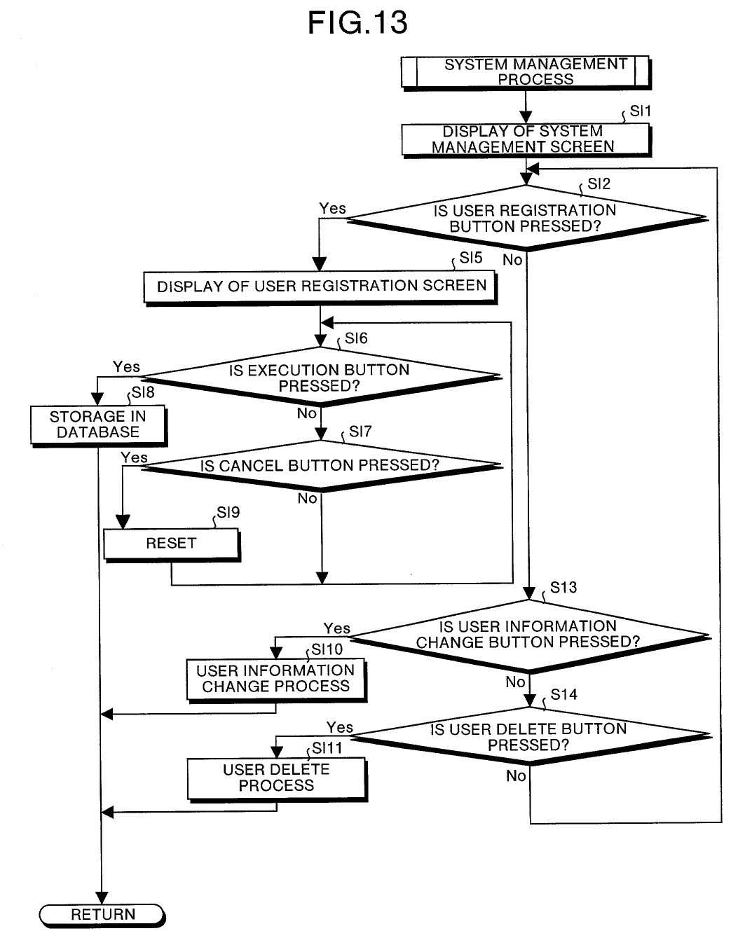

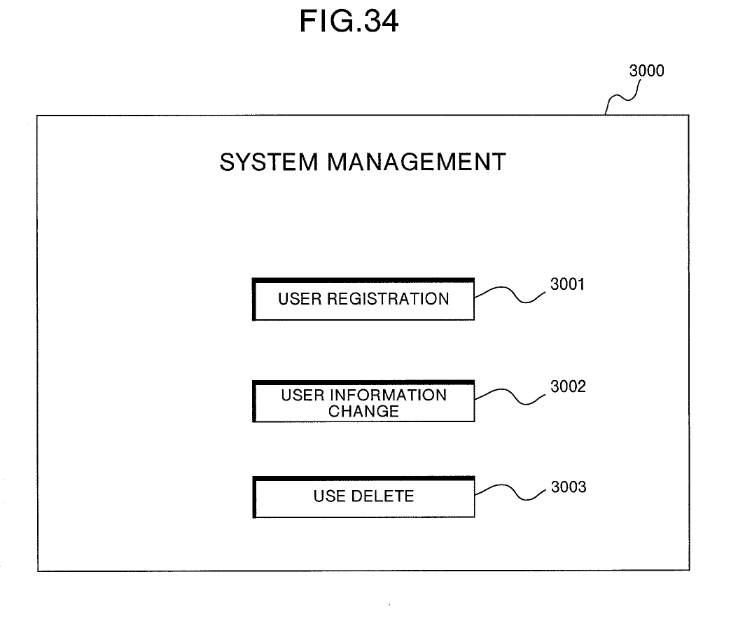

Specifically, at step SI1 shown in FIG. 13, the main controller 220 displays a system management screen 3000 shown in FIG. 34. This system management screen 3000 is a screen for selecting the management menu (registration, change, deletion). The system management screen 3000 includes a user registration button 3001 for registering the user, a user information change button 3002 for changing the user information, and a user delete button 3003 for deleting the user.

Back to FIG. 13, at step SI2, the main controller 220 judges if the user registration button 3001 is pressed or not, and it is judged No in this case. At step SI3, the main controller 220 judges if the user information change button 3002 is pressed or not, and it is judged No in this case. At step SI4, the main controller 220 judges if the user delete button 3003 is pressed or not, and it is judged No in this case. Thereafter, the main controller 220 repeats the judgment from step SI2 to step SI4.

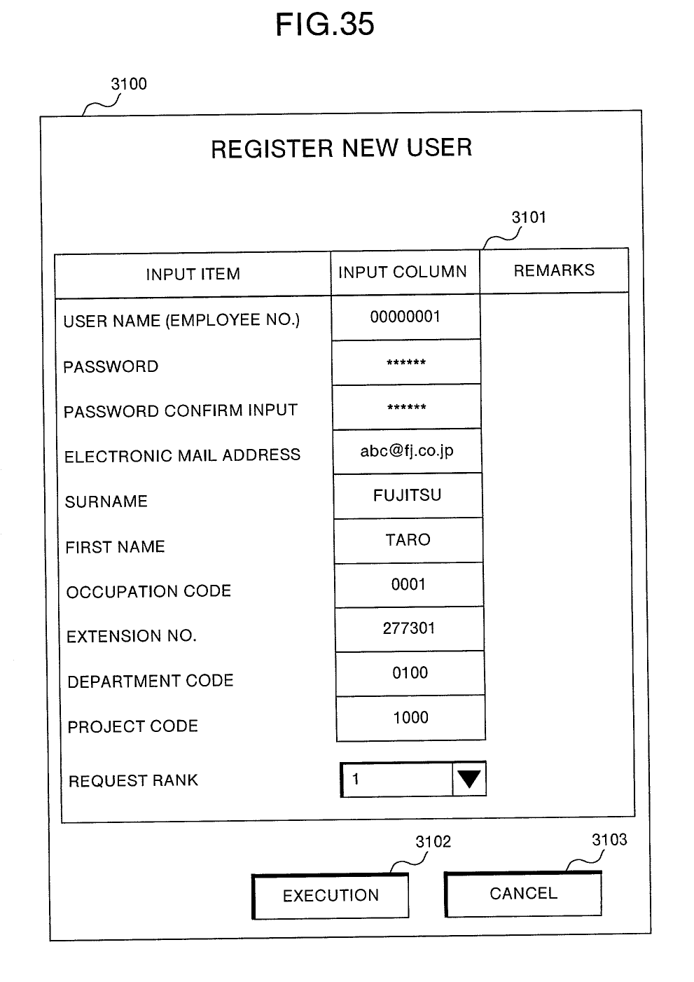

Herein, when the user registration button 3001 is pressed, the main controller 220 judges Yes at step SI2. At step SI5, the main controller 220 displays a user registration screen 3100 shown in FIG. 35. The user registration screen 3100 is a screen for registering the user information corresponding to the user information meta information 310 shown in FIG. 2A. This user registration screen 3100 includes a user information input column 3101 for input of user information (username, . . . , request rank), an execution button 3102 for executing the user registration, and a cancel button 3103.

Back to FIG. 13, at step SI6, the main controller 220 judges if the execution button 3102 is pressed or not, and it is judged No in this case. At step SI7, the main controller 220 judges if the cancel button 3103 is pressed or not, and it is judged No in this case. Thereafter, the main controller 220 repeats the judgment after step SI6.

When the system manager enters the user information in the user information input column 3101 and presses the execution button 3102, the main controller 220 judges Yes at step SI6. At step SI8, the main controller 220 sets the user information in the user information meta information (see FIG. 2A) in the database 300.

When the cancel button 3103 shown in FIG. 35 is pressed, the main controller 220 judges Yes at step SI7. At step SI9, the main controller 220 resets the user information entered in the user information input column 3101.

When the user information change button 3002 shown in FIG. 34 is pressed, the main controller 220 judges Yes at step SI3 shown in FIG. 13. At step SI10, the main controller 220 displays a user information change screen (not shown) for changing the user information already set in the user information meta information 310. As a result, the system manager changes the user information in the user information change screen, and presses the execution button (not shown). The main controller 220 changes the user information meta information 310.

When the user delete button 3003 shown in FIG. 34 is pressed, the main controller 220 judges Yes at step SI4. At step SI11, the main controller 220 displays a user information delete screen (not shown) for deleting the user information already set in the user information meta information 310. As a result, the system manager deletes the user information in the user information delete screen, and presses the execution button (not shown). The main controller deletes the corresponding user information from the user information meta information.

In this embodiment, an unreplied examination result is automatically urged by an urging mail sent to the examiner or replier. Specifically, the main controller 220 monitors the reply status of examination result according to the reply closing term of examination result (see FIG. 20), and automatically transmits urging mails to urge to reply the examination result to the examiner or replier client three days before the closing day, on the closing day, and after a specified period.

As explained herein, according to the embodiment, as shown in FIG. 22 and FIG. 23, the examination requester is allowed to select the examiner or replier according to the attribute information of examiners and repliers, and the examination of examination document is requested to the selected examiner or replier through the Internet 110, and therefore as compared with the conventional method based on paper form, labor and cost required for document examination can be saved.

Furthermore, the examination result of the examination document examined by the examiner or replier is collected, and the examination requester can browse the collected examination result as shown in FIG. 33, so that the examination requester knows the examination result easily.

Furthermore, the importance degree of examination document is set in correspondence to the attribute information of examiners and repliers, and permission and prohibition of browsing is controlled depending on the importance degree, so that leak of confidential information can be prevented, and the security is enhanced.

Furthermore, the reply status of examination result is checked, and examination is urged to the examiner or replier in charge before and after the preset reply closing period, so that the examination requester is not required to urge by telephone or the like, and the labor of the examination requester can be substantially lessened.

Furthermore, various types of information such as the examination document are converted to the XML file and stored in the XML database 400, so that the retrieval efficiency of the XML database 400 can be enhanced by using the XML tag defined originally by the user.

Furthermore, the original file stored in the XML database 400 is presented to the examination requester as the model, and the examination document can be easily compiled on the basis of this model, and the compilation time can be shortened.

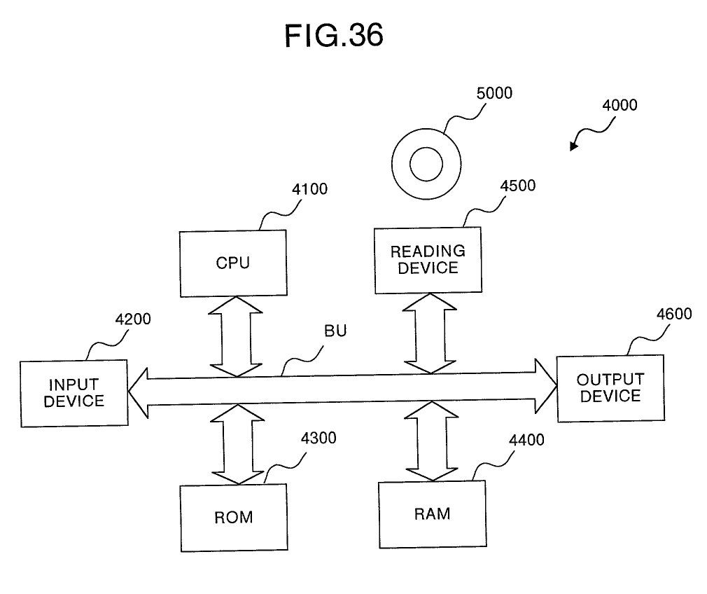

The embodiment of the invention is described herein specifically by referring to the accompanying drawings, but the specific configuration is not limited to this embodiment alone, but various design changes and modifications without departing from the true spirit and scope of the invention should be also included in the invention. For example, in the foregoing embodiment, the document examination program for realizing the function of the server 200 shown in FIG. 1 may be recorded in a computer-readable recording medium 5000 as shown in FIG. 36, and the document examination program recorded in this recording medium 5000 may be read into a computer 4000 shown in the same diagram to be executed, so that the series of processes relating to document examination can be executed.

The computer 4000 shown in FIG. 36 comprises a CPU 4100 for executing the document examination program, an input device 4200 such as keyboard and mouse, a ROM (read only memory) 4300 for storing various data, a RAM (random access memory) 4400 for storing operation parameters, a reading device 4500 for reading the document examination program from the recording medium 5000, an output device 4600 such as display and printer, and buses BU for connecting the parts and devices.

The CPU 4100 reads in the document examination program recorded in the recording medium 5000 through the reading device 4500, and executes the document examination program, and hence execute the series of processes relating to the document examination. The recording medium 5000 includes an optical disk, floppy disk, hard disk, other portable recording medium, and also network and other transfer medium for recording and holding the data temporarily.

Thus, as explained herein, according to the invention, the requester can select the examiner on the basis of the attribute information of the examiner, and the examination of the examination document is requested to the selected examiner through the network, and therefore the labor and cost required in document examination are reduced as compared with the conventional case of requesting in paper form.

Furthermore, the examination result of the examination document examined by the examiner is collected, and the requester can browse the collected examination result, so that the requester knows the examination result easily.

Furthermore, the importance degree of examination document is set in correspondence to the attribute information of examiners, and permission and prohibition of browsing is controlled depending on the importance degree, so that leak of confidential information can be prevented, and the security is enhanced.

Furthermore, the reply status of examination result is checked, and examination is urged to the examiner in charge before and after the preset reply closing period, so that the requester is not required to urge by telephone or the like, and the labor of the requester can be substantially lessened.

Furthermore, the examination results stored in the examination result database are summed up, allowing the requester to browse the examination results, so that the requester knows the examination result easily.

Furthermore, the file of examination results at least converted into an XML format is stored in the examination document database, and therefore the user can search the examination document database by using the XML tag defined originally by the user, so that the retrieval efficiency is enhanced.

Furthermore, the examination document stored in the examination document database is presented as the model, and the examination document can be easily compiled on the basis of this model, so that the compilation time can be shortened.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A document examination apparatus comprising:
an examination document storing unit which stores an electronic examination document in an examination document database,
an attribute information storing unit which stores attribute information of examiners responsible for examining the examination document as an attribute information database,
a selecting unit for allowing a requester to select an examiner on the basis of the attribute information of examiners, and
an examination requesting unit which requests examination of the examination document to the examiner selected by the a selecting unit through a network.

2. The document examination apparatus according to claim 1, further comprising:
an examination document browsing unit for allowing the examiner to browse the examination document,
a collecting unit which collects the examination result of the examination document examined by the examiner, and
an examination result browsing unit for allowing the requester to browse the examination result collected by the collecting unit.

3. The document examination apparatus according to claim 2, in which the examination document storing unit sets the degree of importance of the examination document corresponding to the attribute information of examiners, and the examination document browsing unit controls permission or prohibition of browsing depending on the degree of importance.

4. The document examination apparatus according to claim 2, further comprising an urging unit which checks the status of collection of the examination result, and urges for an examination to the examiner in charge before and after the preset collection period.

5. The document examination apparatus according to claim 2, further comprising an examination result storing unit which attaches an XML tag to every phrase in the collected examination result, and stores the examination result as an examination result database; and
a summary result browsing unit which sums up the examination results stored in the examination result database, and allowing the requester to browse the summary result.

6. The document examination apparatus according to claim 1, in which the examination document storing unit stores at least the file of the examination documents converted into an XML file in the examination document database.

7. The document examination apparatus according to claim 1, further comprising a model presenting unit which presents an examination document stored in the examination document database as a model when compiling the examination document.

8. A document examination method comprising the steps of:
storing an electronic examination document in an examination document database,
storing attribute information of examiners responsible for examining the examination document in an attribute information database,
allowing a requester to select an examiner on the basis of the attribute information of the examiners, and
requesting examination of the examination document to the selected examiner through a network.

9. A computer program containing instructions, which when executed on a computer, causes the computer to perform the steps of:
storing an electronic examination document in an examination document database,
storing attribute information of examiners responsible for examining the examination document in an attribute information database,
allowing a requester to select an examiner on the basis of the attribute information of the examiners, and
requesting examination of the examination document to the selected examiner through a network.

10. The computer program according to claim 9 causing the computer to further perform the steps of:
allowing the examiner to browse the examination document,
collecting the examination result of the examination document examined by the examiner, and
allowing the requester to browse the collected examination result.

11. The computer program according to claim 10, wherein when storing the examination document, a degree of importance of the examination document is set corresponding to the attribute information of examiners, and a permission for browsing is given in accordance with the degree of importance.

12. The computer program according to claim 10, causing the computer to further perform the step of checking the status of collection of the examination result, and urging examination to the examiner in charge before and after the preset collection period.

13. The computer program according to claim 10, causing the computer to further perform the steps of:
attaching an XML tag to every phrase in the collected examination result;
storing the examination result in an examination result database;
summing up the examination results stored in the examination result database; and
allowing the requester to browse the summary result.

14. The computer program according to claim 9, wherein at least the file of the examination documents converted into an XML file is stored in the examination document database.

15. The computer program according to claim 9, causing the computer to further perform the step of presenting an examination document stored in the examination document database as a model when compiling the examination document.
